(19) United States
(12) Patent Application Publication
(10) Pub. No.: US 2013/0179213 A1
(43) Pub. Date: Jul. 11, 2013

(54) CAPITAL ASSET INVESTMENT PLANNING METHODS

(71) Applicant: Copperleaf Technologies Inc., Burnaby (CA)

(72) Inventors: Stanley T. Coleman, West Vancouver (CA); Nicholas Malcolm, Burnaby (CA); Joseph Gnocato, Coquitlam (CA); Daryl Norman Spencer, Coquitlam (CA); Simon Nesbitt Horner, West Vancouver (CA)

(73) Assignee: Copperleaf Technologies Inc., Burnaby (CA)

(21) Appl. No.: 13/709,999

(22) Filed: Dec. 10, 2012

Related U.S. Application Data
(60) Provisional application No. 61/568,635, filed on Dec. 8, 2011.

(51) Int. Cl. G06Q 10/06

(52) U.S. Cl. CPC G06Q 10/06315
USPC 705/7.25

(57) ABSTRACT

Automated systems and methods for use in managing collections of capital assets determine optimal replacement dates for assets based on total cost curves. Replacement dates are adjusted within ranges that avoid unacceptable risk of unmonetizable failures to satisfy constraints. Priority in adjusting replacement dates is determined based on deferral cost metrics which may be based on the total cost curves.

### CROSS-REFERENCE TO RELATED APPLICATIONS

This application claims priority from U.S. Application No. 61/568,635 filed 8 Dec. 2011. For purposes of the United States, this application claims the benefit under 35 U.S.C. §119 of U.S. Application No. 61/568,635 filed 8 Dec. 2011 and entitled CAPITAL ASSET INVESTMENT PLANNING APPARATUS, SYSTEMS AND METHODS which is hereby incorporated herein by reference for all purposes.

### TECHNICAL FIELD

The invention relates to apparatus, systems and methods useful for planning capital asset investments and managing systems made up of capital assets. Particular embodiments provide automated tools useful for determining replacement schedules for in-place capital assets.

### BACKGROUND

Many businesses face challenges in managing large numbers of pieces of equipment or other capital assets. An example of such a challenge is determining when to replace particular capital assets. In making this determination businesses will typically attempt to sensibly balance a large number of competing considerations. These considerations may vary between assets of different types and/or among assets of the same type, and may change over time. The complexity of the considerations that go into determining when to replace or refurbish an in-place capital asset is frequently compounded by the fact that any decision regarding one particular asset often constrains or otherwise impacts decisions made about other assets.

The set of capital assets maintained by a typical larger organization is a complex system that, like a complicated machine, requires maintenance to continue to operate smoothly to provide production for the organization (whether that production be electrical power, manufactured products, minerals, oil or gas, farm produce, lumber, services supported by infrastructure made up of the capital assets, etc.). Furthermore, many organizations have a sufficiently large pool of capital assets that it can be impossible to maintain production without careful scheduling of maintenance and replacement of various capital assets. If too many assets require replacement, upgrading or maintenance at the same time then it may be impossible to achieve the required replacement, upgrading or maintenance at all or within constraints imposed by the availability of resources.

FIG. 1 is a schematic diagram illustrating a non-limiting example of a capital asset management problem. FIG. 1 illustrates assets 10 of an example electric utility network. FIG. 1 is based on the work entitled Electricity Grid Schematic English by MBizon found at http://en.wikipedia.org/wiki/File:Electricity_Grid_Schematic_English.svg, and is included herein under the Creative Commons Attribution 3.0 Unported License, the terms of which may be found online at http://creativecommons.org/licenses/by/3.0/legalcode.

Assets 10 include a plurality of electric generating assets, namely thermal generation plants 11, a nuclear generation plant 12, a hydroelectric generation plant 13, solar panels 14 and wind turbines 15. Assets 10 also include a plurality of distribution assets, namely extra high voltage transmission towers 16, high voltage transmission towers 17, low voltage power poles 18, a variety of transformers 19, and various power lines 19A. Each asset 10 plays a role in the business of the electric utility. Assets 10 require ongoing maintenance in order to ensure their continued operation. Eventually, assets 10 may reach a point at which they cannot be maintained or their continued operation is sufficiently expensive or uncertain that they must be replaced or refurbished. A large organization may have thousands or millions of pieces of equipment. It is a constant challenge to decide when individual pieces of equipment should be replaced or refurbished.

Though it may be possible to forecast when a particular asset 10 will reach the end of its useful life, it may be desirable to replace assets 10 before they reach the end of their lives. For example, maintenance costs near the end-of-life of an asset 10 may be sufficiently high to justify earlier replacement or replacement of an asset at its forecast end of life may be unduly disruptive to the business. For these and myriad other reasons, the electric utility may choose to prioritize and schedule replacement of assets 10. Such prioritizing may be subject to constraints. For example, there may be constraints that limit expenditures for replacing capital assets in individual fiscal periods and/or limited resources to manage or implement replacements of capital assets. The complexity of the considerations and interactions among assets 10 is such that it is very difficult to make optimum replacement scheduling decisions and to understand the likely financial impact of such decisions. Other large organizations face the same problem.

There is accordingly need for automated tools, systems and methods that simplify management of capital assets. There is particular need for tools, systems and methods that can simplify and/or improve scheduling or replacement of in-place capital assets.

### SUMMARY

This invention has several aspects. The following description sets out specific example embodiments that illustrate these aspects. However, the invention is not limited to the specific details that are presented below.

The invention has application in managing capital assets of a wide variety of types in a wide variety of businesses. The term ‘capital assets’ is used to broadly encompass such assets. The precise nature of the ‘capital assets’ in a system being managed will vary significantly depending on the nature of the system. Typical examples of capital assets are tangible equipment (such as machines, installations, vehicles, tools), buildings, computer systems, software systems running on computer systems and the like. ‘Capital assets’ do not include financial assets such as stocks, bonds, bank account balances, investments in funds and the like. Furthermore, the management in question relates to the maintenance of a system which includes capital assets that are used in a business. The system may itself produce a product (e.g. electricity, water, natural gas, oil, manufactured goods etc.) and/or may facilitate one or more activities within a business (e.g. transportation of goods, logistics, fleet maintenance, data communication, or the like. The maintenance involves physical replacement, refurbishment, major maintenance and the like of capital assets in the system and/or the addition of new capital assets into the system. The maintenance is directed to maintaining and improving performance of the managed system over time.

As described below, embodiments of the invention obtain and use information about physical characteristics of capital assets (such information obtained, for example, by conducting tests on the capital assets, monitoring performance of the capital assets, monitoring environment of the capital assets, modeling degradation of capital assets based on experimental studies and on environmental conditions of the capital assets and the like).

Application of the technology as described herein yields useful, concrete and tangible results. For example:
Example embodiments of the invention may be applied to appropriately schedule maintenance of capital assets (the maintenance may include any or all of replacing assets, upgrading assets, refurbishing assets, conducting major maintenance on assets, and the like). Application of the maintenance according to the schedule may keep the overall system made up of the capital assets operating to facilitate continued production from the overall system.
Methods and apparatus according to certain embodiments of the invention may, additionally or in the alternative generate reports containing information and/or compilations of information that relate to the physical condition of capital assets.
Methods and apparatus according to certain embodiments of the invention may, additionally or in the alternative generate reports containing information and/or compilations of information that relate to the input of resources of various types that may be required to maintain a collection of capital assets.
Methods and apparatus according to certain embodiments of the invention may produce specific maintenance schedules for a group of capital assets.
Methods and apparatus according to certain embodiments of the invention may be applied to maintain overall reliability or production of a system comprising a plurality of capital assets.
Methods and apparatus according to certain embodiments of the invention may be applied to estimate and report on overall reliability or production of a system comprising a plurality of capital assets.

One aspect of the invention provides automated tools that are useful for establishing a schedule for replacing, refurbishing or otherwise upgrading equipment or other capital assets that may be used by a business. Equipment may include, for example, devices, machines, installations, tools, and vehicles. Another aspect of the invention provides automated methods for assisting in the prioritizing and scheduling of replacement, refurbishing or upgrading of equipment or other capital assets. Some aspects of the invention provide automated methods for assisting in the prioritizing and scheduling of installation of new assets. A range of non-limiting aspects of the invention is set out in the accompanying claims.

One example aspect provides apparatus for scheduling investments in capital assets. The apparatus comprises a data processor and a database accessible to the data processor. The database stores or is adapted to store asset information for each of a plurality of in-place capital assets. The asset information for each of the in-place capital assets comprises at least: replacement deferral risk cost information, first use cost information, second use cost information, and replacement cost information. A non-transitory medium contains software instructions readable by the data processor. The non-transitory medium may, for example, comprise a data store, a hard drive, an optical data storage medium, a solid-state data store or the like. The software instructions are configured to cause the data processor to, for each of the in-place capital assets: execute a replacement deferral risk cost model with the replacement deferral risk cost information as an input, the replacement deferral risk cost model estimating costs of failure risked by deferring replacement of the in-place asset as a function of time; execute a first use model with the use cost information as an input, the first use model estimating use costs of the in-place capital asset as a function of time; execute a second use model with the second use cost information as an input, the second use model estimating use costs of a replacement for the in-place capital asset as a function of time; execute a replacement cost model with the replacement cost information as an input, the replacement cost model estimating costs of replacing the in-place asset with the replacement asset as a function of time; determine from outputs of the replacement deferral risk cost model, the first and second use models and the replacement cost model a total cost function for the in-place capital asset over a planning period as a function of replacement date for the in-place capital asset; determine a financially optimal replacement date for the in-place capital asset based on the total cost function; and store and/or output to non-transitory media a record comprising the financially optimal replacement dates for one or more of the in-place capital assets.

Another example aspect provides machine implemented methods for scheduling investments in capital assets. The methods comprise, for each of a plurality of in-place capital assets under management: executing by a data processor a replacement deferral risk cost model with replacement deferral risk cost information as an input, the replacement deferral risk cost model estimating costs of failure risked by deferring replacement of the in-place asset as a function of time; executing by the data processor a first use model with first use cost information as an input, the first use model estimating use costs of the in-place capital asset as a function of time; executing by the data processor a second use model with second use cost information as an input, the second use model estimating use costs of a replacement for the in-place capital asset as a function of time; executing by the data processor a replacement cost model with replacement cost information as an input, the replacement cost model estimating costs associated with replacing the in-place asset with the replacement asset as a function of time; determining by the data processor from outputs of the failure model, the first and second use models and the replacement cost model a total cost function for the capital asset over a planning period as a function of replacement date for the capital asset; determining by the data processor a financially optimal replacement date for the in-place capital asset based on the total cost function; and storing and/or outputting to non-transitory media a record comprising the financially optimal replacement dates for one or more of the in-place capital assets.

Another example aspect provides systems for scheduling investments in capital assets. The system comprise a database storing information about a plurality of in-place capital assets; a replacement deferral risk cost model operable to estimate costs associated with failure of one of the in-place capital assets risked by deferring replacement of the one of the in-place capital assets as a function of time; a first use model operable to estimate use costs of the one of the in-place capital assets as a function of time; a second use cost model operable to estimate use costs of a replacement for the one of the in-place capital assets as a function of time; a replacement cost model operable estimate costs associated with replacing the one of the in-place assets with the replacement asset as a function of time; and a processor configured to process outputs of the replacement deferral risk cost model, the first and second use models and the replacement model to provide a total cost function for the one of the in-place capital assets over a planning period as a function of replacement date for the one of the in-place capital assets and to determine an optimal replacement date for the one of the in-place capital assets based on the total cost function.

A further example aspect provides apparatus for use in managing equipment, the apparatus comprising: a data processor configured by software instructions to provide, for each of a plurality of items of equipment, a cost function having an output indicating total financial cost associated with the equipment as a function of a replacement time for replacing the equipment. The apparatus also includes a scheduler for scheduling replacement times for the plurality of items of equipment based in part on the outputs of the corresponding cost functions and based in part on one or more resource constraints. The scheduler is configured to establish proposed replacement times for the plurality of items of equipment that correspond to minima of the corresponding cost functions and to defer replacement of one or more of the items of equipment to satisfy the one or more resource constraints based on a deferral cost metric.

Another example aspect provides a method for managing replacement of items of equipment. The method comprises processing by a data processor information about the items of equipment to yield an output of a cost function relating a financial cost associated with the item of equipment to a replacement time for the item of equipment. The method further comprises processing the outputs and an investment constraint by the data processor to schedule replacement times for the items of equipment, the processing comprising deferring scheduled replacement of one or more of the items of equipment to satisfy the investment constraint in a priority order based on a deferred cost metric for the items of equipment and outputting the schedule.

Yet another example aspect provides a method for managing a system comprising a plurality of capital assets. The method comprises, for each of a plurality of the capital assets, by a data processor executing software instructions: based at least in part on information relating to physical conditions of the capital asset, modeling a risk of failure of the capital asset as a function of time; modeling a cost of failure of the capital asset as a function of time; modeling a cost of replacement of the capital asset as a function of time; modeling costs of operating the capital asset as a function of time; modeling costs of operating a replacement for the capital asset as a function of time; establishing as a replacement date for the capital asset, a date at which a total cost associated with the capital asset is minimized; for a time period, determining whether the total modeled costs of replacement of the capital assets exceed a resource constraint; determining a priority for the capital assets based at least in part on a rate of increase of the total costs associated with the capital asset as a function of the replacement date at the established replacement date; and deferring replacement dates for at least some of the plurality of capital assets taken in order of the corresponding determined priorities until the total modeled costs of replacement of the capital assets do not exceed the resource constraint for the time period. In some embodiments the resource constraints are financial constraints. In some embodiments the resource constraints include constraints on available manpower, machinery, materials, or other resources instead of or in addition to financial constraints.

Further aspects of the invention and example embodiments are illustrated in the drawings and/or described below.

### BRIEF DESCRIPTION OF THE DRAWINGS

The drawings show non-limiting example embodiments.

FIG. 1 is schematic diagram of a non-limiting example capital asset management problem.

FIG. 2 is a graph of example cost curves.

FIG. 3 is a schematic diagram of an automated tool for scheduling investment in capital assets according to an example embodiment.

FIG. 4 is flowchart of a method for determining a total cost curve of an in-place capital asset according to an example embodiment.

FIG. 5 is a flowchart of a method for determining a financially optimal replacement date for an in-place capital asset according to an example embodiment.

FIG. 6 is a flowchart of a method for determining an unmonetizable risk replacement date for an in-place capital asset according to an example embodiment.

FIG. 7 is flowchart of a method for determining a capital asset replacement schedule according to an example embodiment.

FIG. 8 is a graph of capital asset investments according to an example capital asset replacement schedule.

FIG. 9 is a flowchart of a method for prioritizing replacements of in-place capital assets according to an example embodiment.

FIG. 10 is a flowchart of a method for deferring scheduled capital investments of a capital asset replacement schedule according to an example embodiment.

FIG. 11 is a flowchart of a method for deferring scheduled capital investments of a capital asset replacement schedule according to another example embodiment.

FIG. 12 is a flowchart of a method for deferring scheduled capital investments of a capital asset replacement schedule according to a further example embodiment.

FIG. 13 is a flowchart of a method for determining a consensus capital asset replacement schedule according to an example embodiment.

FIG. 14 is a schematic diagram of an apparatus for generating a capital asset replacement schedule according to an example embodiment.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

It is generally desirable to schedule or plan for replacement of in-place capital assets. The total cost of replacing or otherwise investing in refurbishing or upgrading a particular in-place capital asset is a factor that may be considered in determining when that asset should be replaced, refurbished or upgraded. Except where otherwise stated or implicitly required the term ‘replace’ when used below includes: replacing, refurbishing and/or upgrading.

It is generally preferable to replace an asset at or about the time that will minimize the net present value of the total cost associated with the asset over a period of time. This preferable replacement time may be determined by modelling the costs associated with the asset. A mathematical model of the costs associated with an asset may be executed on a computer to yield a cost curve or cost function from which the preferable replacement data may be determined. An estimate of the total cost associated with an in-place capital asset may be determined, for example, based on estimates of the failure risk cost that accrues when replacement of the asset is deferred, the lost advantage cost of continuing to use the in-place asset instead of its replacement, and the costs associated with replacing the asset.

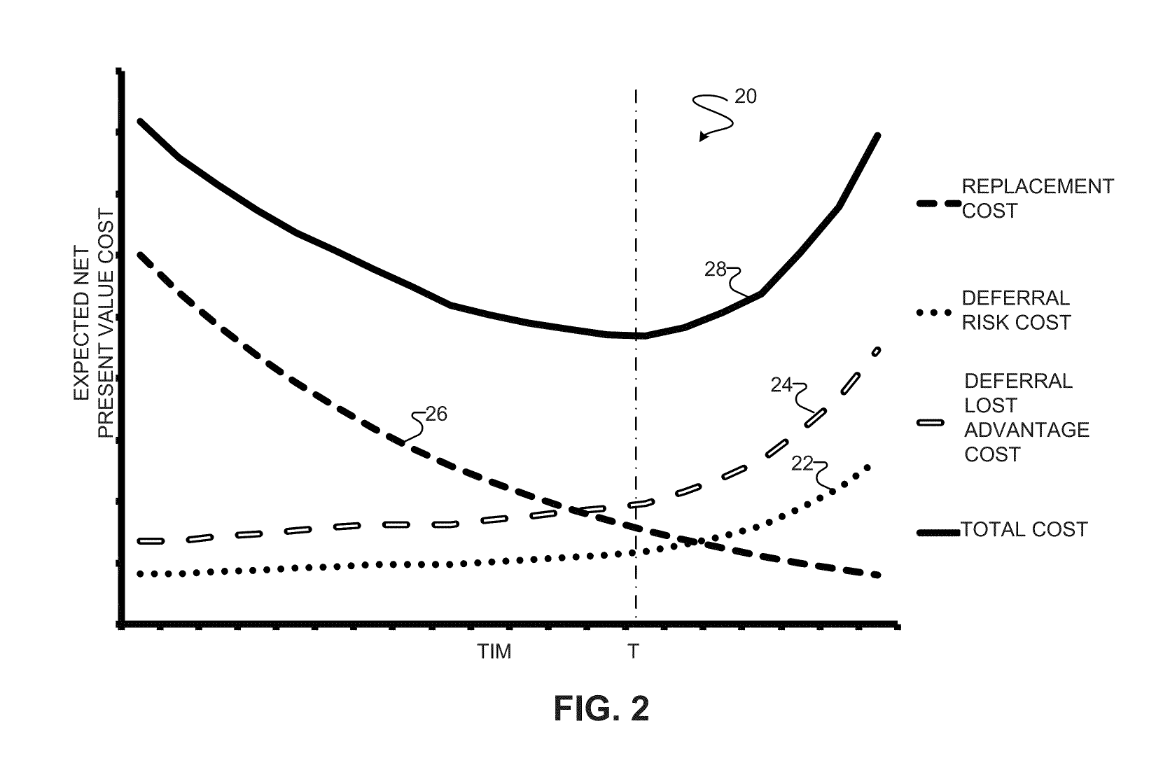

FIG. 2 is a graph 20 comprising a plurality of example cost curves indicative of the total cost associated with replacing an in-place capital asset as a function of time. More particularly, graph 20 shows:
a cost curve 22 representative of the risk cost of deferring replacement of the in-place capital asset,
a cost curve 24 representative of the lost advantage cost of deferring replacement of the in-place capital asset, and
a cost curve 26 representative of the cost to replace the in-place capital asset with a replacement capital asset at a particular point in time.
   Cost curves 22, 24, and 26 express their respective costs discounted to net present value (vertical axis) over a range of time (horizontal axis).

Cost curve 22 has upward slope that increases over time, which indicates that the risk cost of deferring replacement of the in-place capital asset increases faster as the asset ages. The increasing slope of curve 22 may be due, for example, to the fact that the probability of failures increases as the in-place capital asset ages and/or the costs of consequences associated with failures increase over time.

Cost curve 22 may reflect both costs that make unscheduled replacement of the in-place capital asset precipitated by unanticipated failure more costly than scheduled replacement (such as overtime, urgent acquisition of parts and services, and the like) and costs arising from unanticipated failure of the in-place asset (such as costs associated with, lost production, acquiring a replacement for the production that the failed asset would have made had it not failed, having to meet demand left unfulfilled due to the failure, environmental damage, collateral damage to other assets, injury and/or loss of life, liability to customers, damage to the organization's brand, loss of goodwill, fines, etc.). For convenience, these foregoing costs may be categorized as either “direct costs” of the failure of the in-place capital asset (e.g., costs incurred for unscheduled replacement, costs of lost production, costs of filling unmet demand due to lost production etc.) or “indirect costs” of the failure of the in-place capital asset (e.g., collateral damage to other assets, damage to brand, loss of goodwill, etc.).

Cost curve 22 may take into account not only degradation of capital assets with time but also improvements in reliability of capital assets that may occur as a result of significant scheduled maintenance activities. For example, while a capital asset remains in operation the capital asset may receive one or more interim maintenance events that may be significant enough to temporarily improve the reliability of the capital asset (or at least reduce the rate at which the reliability of the capital asset declines with aging). In some embodiments cost curve 22 assumes that such interim maintenance will occur on an assumed schedule but does not schedule the interim maintenance events themselves. In other embodiments, the apparatus and methods described herein are applied to schedule at least some interim maintenance events.

In estimating the component of the cost due to lost production of a failed capital asset, the model may take into account the degree to which other capital assets may be used temporarily to make up for the lost production of the capital asset to which the model relates. For example, where the capital asset is a production unit and there are other production units co-located with the capital asset to which the model relates then the co-located production units may be able to temporarily make up some or all of the lost production. For example, a hydroelectric generator may be co-located with other hydroelectric generators. In normal operation all of the hydroelectric generators may be run at less than 100% of their full capacity (e.g. for increased lifespan). If one hydroelectric generator were to fail, the others could temporarily be run closer to their capacities, thereby reducing or eliminating the shortfall in production of the failed generator. The model may take this into account. Similarly, where the capital asset is a production unit for which there is a standby unit the model may take into account the fact that operation of the standby unit may partially or completely replace lost production from the unit being modeled. In either case, the model may include added costs associated with making up the lost production (e.g. costs of bringing a backup unit on line, costs of configuring other units to operate at higher capacity, added maintenance costs etc.)

In estimating the component of the cost due to lost production of a failed capital asset, the model may take into account the degree to which any lost production may be made up after the failed asset is replaced, repaired or otherwise brought back into operation. For example, where the asset is a hydroelectric generator that receives water from a dammed reservoir it may be possible to accumulate water behind the dam while the generator is being repaired. After the generator is repaired then it may be operated to generate electrical power from the water that has built up behind the dam. By contrast, where the asset is a run-of-river generator or a wind turbine or a solar generator that is not made in a way that permits storing energy for later conversion to electrical power production is lost while the asset is being replaced, repaired or otherwise being brought back into production.

In estimating the component of the cost due to lost production of a failed capital asset, the model may take into account seasonal or other variations with time in the cost of lost production. For example, where the capital asset being considered is a hydroelectric generator the model may take into account the fact that more production will be lost if the generator fails at a time of year when water is plentiful (and the generator would be operating close to its capacity) than if the generator fails at a time of year when water is scarce (and the generator would be operating well below its capacity).

In estimating the component of the cost due to lost production of a failed capital asset, the model may take into account variations in the value of the production of the capital asset with time. These variations may include seasonal variations. For example, where the asset is an electricity generator, the model may take into account the fact that electricity is in more demand at certain times of the year (and may therefore have a higher value) than it does at other times of year.

Cost curve 24 has upward slope that increases over time, which indicates that the lost advantage cost of not replacing the in-place capital asset with the replacement asset increases faster with time. Cost curve 24 expresses the relative cost advantage of using the replacement capital asset instead of the in-place capital asset. For instance, if at a given point in time the expenditures that would be required to service the replacement capital asset are less than the expenditures that would be required to service the in-place capital asset, this represents a net cost advantage of the replacement capital asset over the in-place capital asset. If at a given point in time the in-place capital asset is in place instead of the replacement asset, this cost advantage is lost—in other words, cost curve 24 indicates that deferring replacement of the in-place asset is effectively an election to incur greater costs.

Non-limiting examples of other considerations that may be factored into cost curve 24 include:
expected efficiency advantages of the replacement asset (e.g., differences in operating costs required to yield equivalent output);
expected differences in income losses due to downtime for operating maintenance, minor serviceable failures, etc., as between the in-place asset and the replacement asset;
expected differences in future insurance premiums as between the in-place asset and the replacement asset;
expected differences in costs for disposing of waste products generated by the in-place asset and the replacement asset;
expected additional income generated by the replacement asset (e.g., due to ongoing production of carbon offsets);
expected costs of inability of the in-place asset to meet demand, which demand could be met by the replacement asset;
expected differences in depreciation costs of the in-place capital asset and the replacement asset;
and the like.

Cost curve 26 has downward slope that decreases over time, which indicates that the net present value of the cost to replace the in-place capital asset decreases more slowly with time. This may be due, for example, to the fact that replacing the in-place capital asset involves a relatively large expenditure over a relatively short period of time. The net present value of that expenditure may decrease as it is deferred into the future. The downward slope of curve 26 may also be attributable to the fact that technology advances may make the replacement capital asset less expensive to acquire and/or install, but with declining incremental advantage over time. Cost curve 26 may reflect both direct costs of scheduled replacement of the in-place capital asset with the replacement capital asset (such as the costs to decommission the in-place capital asset, residual value of the in-place capital asset, and costs to purchase and install the replacement capital asset, for example) and indirect costs of scheduled replacement of the in-place capital asset (such as lost income due to downtime between the in-place capital asset being taken out of service and the replacement capital asset being put into service, and one-time income attributable to carbon offsets earned by installing a more carbon efficient asset, for example).

Graph 20 shows a total cost curve 28. Total cost curve 28 represents the total net present value cost associated with the in-place capital asset as a function of the time at which replacement of the capital asset is initiated. In the illustrated embodiment, total cost curve 28 is saddle-shaped. The time at which the total net present value cost associated with the asset is lowest corresponds to the minimum of total cost curve 28. In graph 20, the optimum time to replace the in-place capital asset with the replacement capital asset is marked with a line at time T.

The total cost curve for some types of in-place capital assets is monotonically decreasing. It may be desirable to run such assets to failure rather than schedule their replacement. Tools and methods described herein may be adapted for use with run-to-failure in-place capital assets. For example, similar run-to-failure assets may be pooled together, the expected replacement costs for the pool in a given time period determined as the product of the pool population and the proportion of the assets in the pool expected to reach the end of their useful lifetimes in the relevant period, and the expected replacement costs factored into investment constraints (e.g., as a pre-emptive claim on a fiscal budget). An in-place capital asset may be treated as a run-to-failure asset even though its total cost curve is not monotonically decreasing.

In determining when to replace a particular in-place capital asset, it is generally desirable to schedule replacement at or near the time when the total cost curve for the asset is at its minimum. Another potentially relevant factor in determining when to replace a particular in-place capital asset is the probability that the asset will experience a failure whose consequences the organization is unprepared or unable to monetize. Some types of capital assets are susceptible to types of failures that have consequences that an organization may be unprepared to or unable to monetize (e.g., loss of human life, environmental damage, property damage, catastrophic business disruption, etc.). For these types of assets, replacement may be deemed mandatory when the probability of a failure having such an unmonetizable consequence (for convenience, an “unmonetizable failure”) is too great to be tolerated. Another potentially relevant factor in determining when to replace a particular in-place capital asset is obsolescence of the asset. For example, even if an asset is still working it may be desirable to ensure that certain assets are replaced before they become technologically obsolete (and therefore harder and more expensive to maintain). While obsolescence could be taken into account in a cost function, it can be easier to set a date by which certain systems should be replaced to avoid maintenance of obsolete systems. For example, a company may wish to ensure that electronic control systems are replaced before they become technologically obsolete. In some embodiments, an obsolescence date may be a date after which a supplier has indicated that support for the capital asset will no longer be available.

Obsolescence may be handled, for example, by setting a hard date by which a system must be replaced (e.g. treating obsolescence as a type of unmonetizable risk in the same manner as described above for unmonetizable risk) or by modifying a cost function for scheduling purposes in such a manner that costs are increased significantly after the obsolescence date. This may be done, for example, by including in the cost function a factor that is equal to one up to the obsolescence date and then rises after the obsolescence date and/or by adding to the cost function an amount that is zero before the obsolescence date and then rises after the obsolescence date. It is possible but not necessary for the factor or added amount to even attempt to accurately model costs for maintaining obsolete systems since the purpose of the factor is to force replacement of systems by no later than a time that is at or shortly after the obsolescence date (i.e. to make the obsolescent system a high priority for replacement when its obsolescence date has been reached).

A further factor that may be material to the determination of when to replace a particular in-place capital asset is the organizational capacity to invest in the replacement or to carry out the replacement. In organizations where many capital assets must be managed, there may be investment constraints (e.g., fiscal constraints, human resources availability, equipment availability, etc.). Such constraints may prevent every asset from being replaced at its optimal replacement date. Where investment constraints make it impossible to schedule replacement of in-place assets at their optimal replacement dates, it is necessary to schedule replacements of at least some assets at sub-optimal replacement dates. It is preferable that departures from the optimal replacement schedule taken to satisfy investment constraints be cost-efficient.

As is made more apparent below, determining cost-efficient schedules for replacement of in-place assets that meet both unmonetizable consequence constraints and investment constraints is an undertaking whose complexity, both logical and computational, expands dramatically with increased refinement of the asset models employed and the number of assets that must be considered. For businesses managing more than a few dozen capital assets of different types, and employing models sufficiently sophisticated to obtain reasonably accurate projections, determining a cost-efficient schedule for replacing the assets cannot, as a practical matter, be performed entirely in a human's mind or by a human without technological assistance and accordingly requires use of a machine.

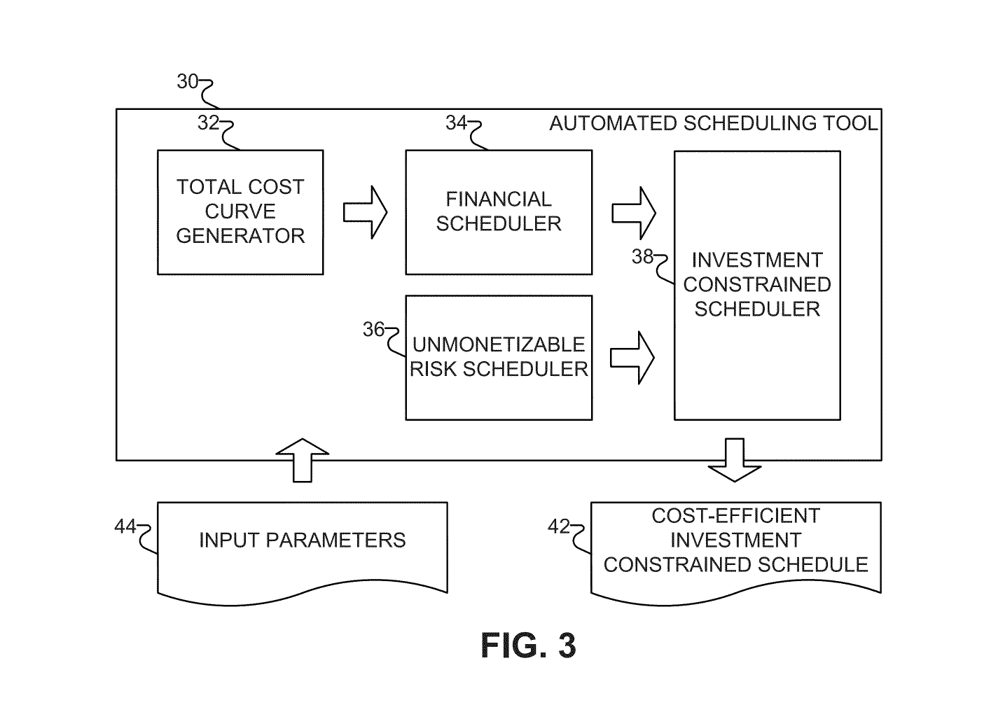

Some embodiments of the invention provide automated tools for determining cost-efficient schedules for replacing in-place capital assets. FIG. 3 is a schematic diagram of one such automated in-place capital asset replacement scheduling tool 30 according to an example embodiment. Automated tool 30 comprises the following components:
a total cost curve generator 32, which is configured to generate total cost curves for a plurality of in-place capital assets;
a financial scheduler 34, which is configured to determine a financially optimal replacement date for each of the in-place capital assets based on the total cost curves generated by total cost curve generator 32;
an unmonetizable risk scheduler 36, which is configured to generate unmonetizable risk replacement dates for the ones of the in-place assets susceptible to failure having an unmonetizable consequence;
an investment constrained scheduler 40, which is configured to determine, based on the financially optimal replacement dates determined by financial scheduler 34 and the unmonetizable risk replacement dates determined by unmonetizable risk scheduler 36, if any, for the in-place capital assets, a cost-efficient investment constrained replacement schedule 42 (i.e., a financially optimal replacement schedule that satisfies unmonetizable risk requirements, and corresponds to an investment schedule that is compatible with investment constraints).

Automated tool 30, including some or all of its components, produce output based on input parameters 44. Non-limiting examples of input parameters are explained below.

Apparatus 30 may, for example, comprise a computer executing software instructions. The computer may retrieve input parameters 44 from a database or other data store and output schedules 42.

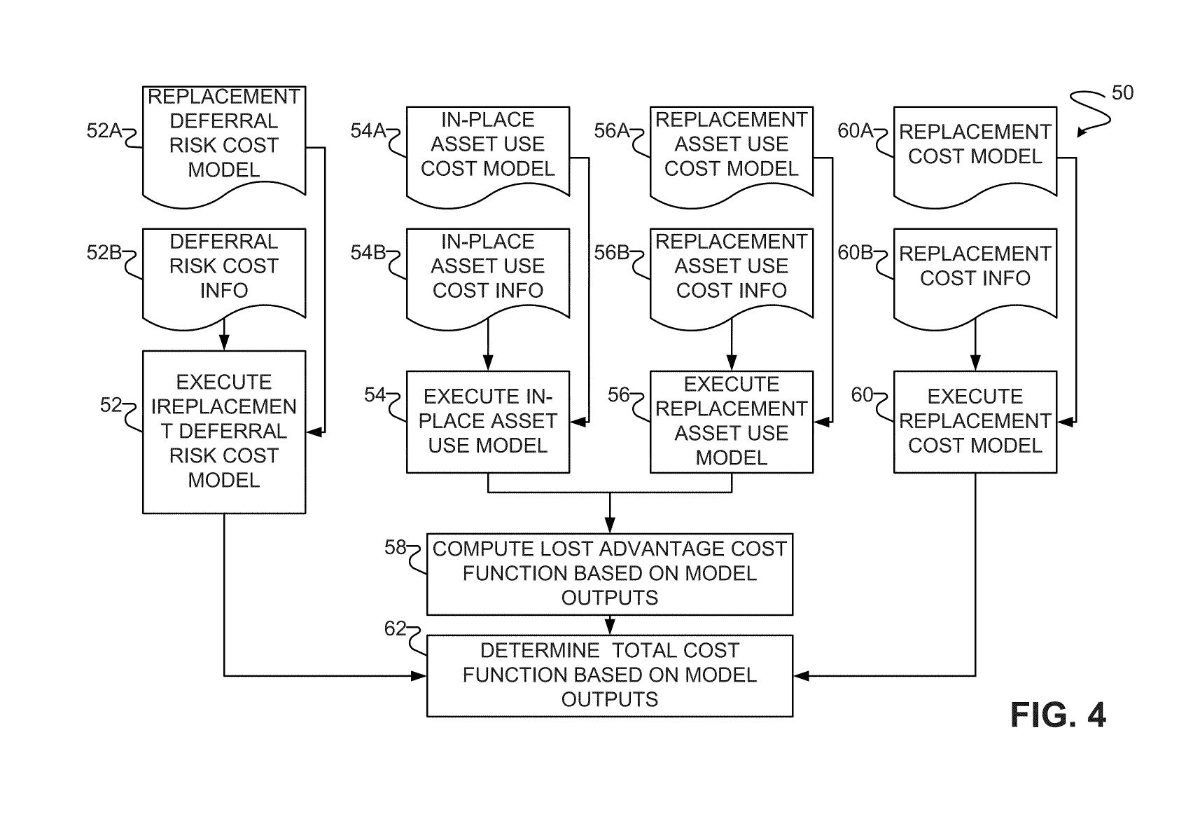

FIG. 4 is a flowchart of a method 50 for determining a total cost function for an in-place capital asset according to an example embodiment. Cost curve 28 is a plot of an example total cost function for a capital asset that may be determined by performing method 50. Total cost curve generator 32 may be configured to perform one or more steps of method 50. Method 50 may be performed to determine total cost functions for a plurality of different capital assets.

Step 52 of method 50 comprises executing a replacement deferral risk cost model 52A for the in-place asset as a function of time, the model having replacement deferral cost information 52B as input. Model 52A models risk costs associated with at least one potential failure event risked by deferring replacement of the in-place asset. Risk costs modeled by model 52A may vary as a function of time due to changing probabilities and/or failure consequences, for example.

Replacement deferral cost information 52B may comprise information pertaining to failure probabilities, failure costs, failure modes and/or the like, for example. Replacement deferral cost information 52B may comprise and/or be based at least in part on information regarding the physical condition of the in-place asset. For example, replacement deferred cost information may include information quantifying wear of components of a machine information relevant to the physical condition of the machine, or other information relevant to the expected life of the machine and/or expected maintenance costs for the machine Replacement deferral cost information 52B may include statistical information about failure rates of assets similar to the in-place asset as a function of time. Such statistical information regarding the probability of failure as a function of time may be based at least in part on historical failure rate information collected for assets similar to the in-place asset over time. Replacement deferral risk cost model 52A executed in step 52 provides as output an estimated risk cost for deferring replacement of the in-place asset as a function of time. Cost curve 22 is a plot of deferral risk cost estimated by a particular example failure risk cost model.

In some embodiments replacement deferral risk cost models for one or more different types of equipment or other capital assets are pre-defined. Such pre-defined models may include parameters that allow them to be customized to provide risk costs as a function of time for a specific capital asset. For example, the parameters may include parameters indicative of: a capacity of the asset (e.g. capacity of a generator); a duty of the asset (e.g. is a generator in use 24/7 or only used on a standby basis); a condition of the asset; a type of construction of the asset (e.g. a type of bearings used to support a critical assembly) etc. Such pre-defined models may comprise computer software functions that receive the input parameters and provide deferral risk cost as a function of time as outputs.

By way of non-limiting example, a risk cost deferral model may be embodied in the following expression:

$$R C {D}_{n} = {\sum }_{i = 0}^{n} \frac{( {P}_{failure}^{in \text{-} place} ( i ) - {P}_{failure}^{inherent} ( i ) ) ( D {C}_{failure} ( i ) + I {C}_{failure} ( i ) )}{{( 1 + D R )}^{i}}$$

where:
DR is the discount rate;
P^{in-place}_{failure}(i) is the probability of the in-place asset failing in time interval i;
P^{inherent}_{failure}(i) is the probability of an asset that is properly maintained failing in time interval i;
DC_{failure}(i) is the direct cost of asset failure in time interval i; and
IC_{failure}(i) is the indirect cost of asset failure in time interval i.

The Pᵢₙₕₑᵣₑₙₜ term in the above equation is usually desirable because there is typically some probability that an asset will fail even if it is maintained properly. In other words, even if replacement of the in-place asset is not deferred, the asset is susceptible to failure. Without the Pᵢₙₕₑᵣₑₙₜ term, the probability of such inherent failures could improperly be treated as a cost of deferring replacement. In some embodiments, DC_{failure}(i) and IC_{failure}(i) are constants (i.e., their values do not depend on time i). In some embodiments, different DC_{failure}(i) and IC_{failure}(i) are specified for P_{in-place} and Pᵢₙₕₑᵣₑₙₜ. It is not necessary that costs of failure be broken down into DC_{failure}(i) and IC_{failure}(i).

Method 50 includes determining a lost advantage cost function based on outputs of use models of an in-place capital asset and a corresponding replacement asset. Step 54 of method 50 comprises executing an asset use cost model 54A for the in-place asset as a function of time, the model having in-place asset use cost information 54B as input. Model 54A models operating costs arising from use of the in-place asset. In-place asset use cost information 54B may comprise information related to maintenance costs, input costs to use the asset (e.g., costs of wages, consumable inputs, resources, etc.), income derived from use of the asset (e.g., revenue from sales of output generated by the asset), insurance premiums, taxes on use of the asset (e.g., necessary carbon offset purchases, etc.), expected costs of ongoing risks associated with use of the asset (e.g., lost production due to scheduled maintenance services, failures not requiring replacement of the asset, and the like, etc.) and the like, for example. In-place asset use cost model 54A executed in step 54 provides as output an estimated cost of using the in-place asset as a function of time.

Step 56 of method 50 comprises executing an asset use cost model 56A for the replacement asset as a function of time, the model having replacement asset use cost information 56B as input. Model 56A models operating costs accrued by use of the replacement asset. Replacement asset use cost information 56B may comprise information of the same sort as in-place asset use information. In some embodiments, at least some of replacement asset use cost information 56B and in-place asset use information 56A is the same. Replacement asset use cost model 56A executed in step 56 provides as output an estimated cost of using the replacement asset as a function of time.

In step 58 a lost advantage cost function is determined based on the outputs obtained by executing in-place asset use cost model 54A in step 54 and by executing replacement asset use cost model 56A in step 56. Step 60 may comprise determining a difference between projected use costs of the in-place capital asset estimated by the in-place asset use cost model 54A and projected use costs of the replacement asset estimated by the replacement asset use cost model 56A, for example. Cost curve 24 is a plot of lost advantage cost estimated by a particular example lost advantage cost function.

Step 60 of method 50 comprises executing a replacement cost model 60A, the model having replacement cost information 60B as input. Model 60A models costs associated with replacing the in-place asset with the replacement asset. Replacement cost information 60B may comprise information related to direct costs associated with replacing the in-place capital asset with the replacement capital asset (such as the costs to decommission the in-place capital asset, residual value of the in-place capital asset, and costs to purchase and install the replacement capital asset, for example) and, optionally, indirect costs (such as lost income due to downtime between the in-place capital asset being taken out of service and the replacement capital asset being put into service, and income attributable to carbon offsets earned by installing a more efficient asset, for example). Replacement cost model 56A executed in step 56 provides as output an estimated cost of replacing the in-place asset with the replacement asset as a function of time. Cost curve 26 is a plot of replacement cost estimated by a particular example replacement cost model.

In some embodiments replacement cost models for one or more different types of equipment or other capital assets are pre-defined. Such pre-defined models may include parameters that allow them to be customized to provide replacement costs for a specific capital asset. For example, the parameters may include parameters indicative of: a profile of spending for replacing the capital asset, a cost inflation estimate, the capacity of the asset or the like. Such pre-defined models may comprise computer software functions.

Step 62 comprises determining a total cost function based on the outputs of the models executed in steps 52, 54, 56 and 60. More particularly, step 62 comprises determining from the outputs of the models executed in steps 52 and 60, and from the output of the function determined in step 58, a total cost function for the in-place capital asset over a planning period as a function of replacement date for the in-place capital asset.

Models and functions executed or computed in steps 52, 54, 56, 58, 60, and 62 may comprise one or more of: computable functions (e.g., mathematical formulas, algorithms, etc.), look-up tables, stochastic processes, combinations thereof, or the like, for example. Some embodiments comprise apparatus configured to perform one or more steps of method 50 (e.g., programmed computers, processors executing instructions encoded on non-transitory media, etc.). For example, apparatus may comprise or be configured to access non-transitory media encoded with computer instructions that when executed by a processor execute models, determine functions and/or compute outputs of models and/or functions. Such apparatus may comprise or be configured to access non-transitory media encoded with input information to models and/or functions in databases or other information stores.

Models and functions obtained or determined in steps 52, 56, 58, 60, and 62 may be configured to determine all costs as of the same date to facilitate comparison of the costs. For example, the costs may be discounted to net present value. For example, use costs may be discounted to net present value in steps 54 and 56, or, alternatively, differences in non-discounted use costs may be discounted to net present value in step 58. Various techniques for obtaining cost models and/or functions corresponding to cost curves 22, 24, and 26 are known in the art; these and suitable future developed techniques may be used to obtain cost models, functions and curves.

It can be convenient to represent at least costs in terms of ‘resource units’. Resource units may not directly represent monetary costs. Apparatus as described herein may include one or more tables or other data structures that relate resource units to monetary costs. Resource units of different types may be converted to monetary units according to different conversion functions. Furthermore, the conversion functions for resource units of different types may include different functions for determining the present value of an expenditure of resource units of that type in the future. This structure allows the conversion functions to include models which can take into account such things as future scarcity of certain materials or personnel etc. Additionally the system may include one or more tables or other data structures that indicate limits on the expected availability of resources. For example, a system may include a resource rate table that defines the cost per resource unit. The resource rate table may include entries defining the present cost of resource units in future days months or years. The resource rate table may optionally separately specify resource rates by supplier. Such a system may also comprise a resource supply table that defines the number of resource units expected to be available at times in the future. The resource supply table may, for example, specify resource units expected to be available in future months or future years. The resource supply table may optionally separately specify resource availability by supplier.

Resource units may represent different kinds of costs such as, by way of non-limiting example, person-hours (this may be broken down by field, e.g. engineering hours, management hours, laborer hours, machine operator hours, technician hours, etc.); units of materials of different types; units of fuel; machine hours (e.g. hours of excavator time, helicopter hours, crane hours etc.); units of a crew which may include both personnel and equipment (e.g. hours for a clearing crew, hours of a maintenance crew, hours of a framing crew, hours of a road-building crew etc.).

Allocating costs in terms of resource units of different types facilitates calculation of schedules for replacing capital assets in a manner which permits automatically making the schedules consistent with constraints on future availability of resource units of different types as well as or as an alternative to constraints imposed by monetary budgets for replacing capital assets. This is discussed in more detail below.

Allocating costs in terms of resource units additionally facilitates prediction of the future consumption of resource units of different types. The consumption of resource units of different types as a function of time may be determined by summing resource unit consumption of scheduled projects. This adds to the value of systems as described herein by providing a tool that management can use to predict resource consumption and to ensure that necessary resources will be available, when needed in the future, and/or to identify problems early on.

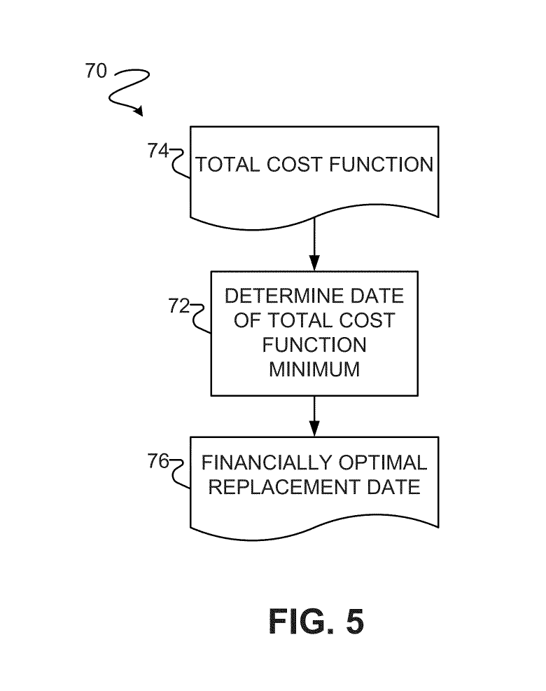

FIG. 5 is a flowchart of a method 70 for determining a financially optimal replacement date for an in-place capital asset according to an example embodiment. In method 70, step 72 comprises determining the date of the minimum of a total cost function 74 for the in-place capital asset—that is, the date when the total cost for the in-place capital asset as a function of replacement date is at its minimum.

Financially optimal scheduler 34 may be configured to perform step 72 with a total cost function 74 generated by total cost function generator 32. In some embodiments, total cost function generator 32 determines the total cost function using costs for replacing an asset based on the estimated consumption of resource units for replacing the asset and on conversion functions (which may comprise or consist of stored conversion data) that convert consumption of resource units of one or more different types into expenditures of monetary units.

The date at which the total cost function is at its minimum may be referred to herein as the “financially optimal replacement date” for convenience. Step 72 may comprise locating a saddle point in total cost function 74, for example. The saddle point may be located by executing a software routine.

In embodiments where total cost function 74 is continuously differentiable, step 72 may comprise obtaining the first derivative of that total cost function, and determining the date(s) of downward zero crossing of the first derivative of the total cost function (which corresponds to a concave upwards inflection point of the total cost function). If there is more than one such date, step 72 may comprise determining the date at which the total cost function has the lowest value.

In embodiments including those where total cost function 74 is not continuously differentiable, step 72 may comprise determining finite differences for adjacent dates in the domain of the total cost function, and identifying a date (or plurality of consecutive dates) across which the finite difference changes sign from negative to positive (e.g., a date corresponding to a concave upwards inflection point of the total cost function). If there is more than one such date, step 72 may comprise identifying the date at which the total cost function has the lowest value as the financially optimal replacement date. If there is more than one such date and the total cost function has the same value at all such dates, step 72 may comprise identifying the latest date as the financially optimal replacement date. In other embodiments, step 72 may perform a search for a minimum value of the total cost function by comparing the values of the total cost function for different dates. Any suitable computer-implemented technique for locating minima of a function may be applied in step 72.

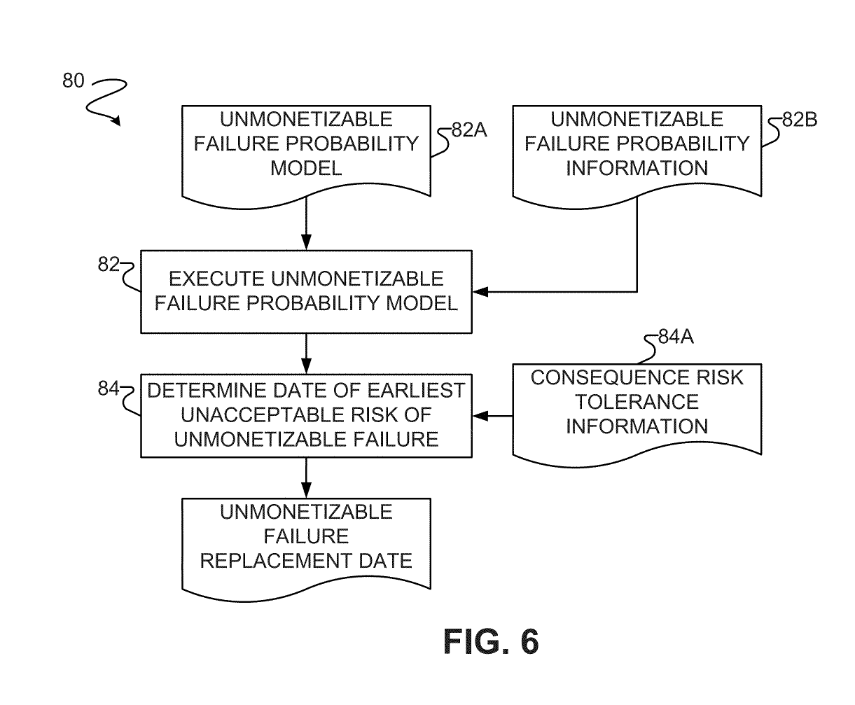

FIG. 6 is a flowchart of a method 80 for determining an unmonetizable risk replacement date for an in-place capital asset according to an example embodiment. Unmonetizable risk scheduler 36 may be configured to perform method 80. In method 80, step 82 comprises executing an unmonetizable failure probability model 82A for an in-place capital asset as a function of time, the model having corresponding unmonetizable failure information 82B as input.

Model 82A models the probability that the in-place capital asset will experience unmonetizable failure as a function of time. Model 82A may model probability of one or more types of unmonetizable failure. An unmonetizable failure probability model 82A executed in step 82 may express probability in numeric terms (e.g., as a number in range the range of 0 to 1), or in qualitative terms (e.g., as rare, unlikely, possible, likely, almost certain, as acceptable, trend to unacceptable or unacceptable, etc.). Unmonetizable failure information 82B may include particular knowledge of asset condition (such as may determined or inferred from results of inspections, stress tests, monitoring, etc.), for example. In some embodiments, method 80 comprises receiving information regarding the condition of a particular in-place capital asset. Such information may be derived by inspecting the asset, testing the asset, or the like.

Step 84 comprises determining the earliest date at which the probability of unmonetizable failure, as provided by the output of the model 82A executed in step 82 with information 82B as input, is unacceptable according to consequence risk tolerance information 84A. The earliest date of unacceptable risk of unmonetizable failure of the in-place capital asset may be referred to herein as the “unmonetizable risk replacement date” for convenience, since it represents the date by which the asset must be replaced to in order avoid an unacceptable risk of unmonetizable failure.

In embodiments where model 82A models multiple types of unmonetizable failure, step 84 may comprise determining an unacceptable unmonetizable failure risk date for each type of unmonetizable failure, and identifying an earliest one of these dates as the unmonetizable risk replacement date for the asset. In some embodiments where model 82A models multiple types of unmonetizable failure, one or more of the types of unmonetizable failure may be associated with a severity level and consequence risk tolerance information 84A may comprise a threshold probability corresponding to each severity level. In such embodiments, step 84 may comprise determining the earliest date at which the probability of each failure type meets or exceeds the probability threshold corresponding to the severity level of the failure type.

In some embodiments, an unacceptable unmonetizable failure risk date may be obtained differently. For example, unacceptable unmonetizable failure risk dates for one or more different types of unmonetizable failures may be stipulated based on government, industry or manufacturer guidelines or the like, which may mandate replacement or refurbishment of certain types of equipment within certain time periods, for example.

Method 90 is a flowchart of a method for determining a cost-efficient investment-constrained replacement schedule. Investment-constrained scheduler 38 may be configured to perform one or more steps of method 90 with financially optimal replacement dates determined by financial scheduler 34 and unmonetizable risk replacement dates determined by unmonetizable risk scheduler 36 as input. In method 90, step 92 comprises determining an optimal replacement investment schedule for the in-place assets based on the financially optimal replacement dates 92A and unmonetizable failure replacement dates 92B of the assets.

Step 92 may comprise determining an optimal replacement schedule for the in-place capital assets by determining an optimal replacement date for each of the in-place capital assets, and determining the optimal investment replacement schedule by scheduling investments to attain the determined optimal replacement dates in view of replacement investment information 92C. In some embodiments, an optimal replacement date is determined as the earlier of the asset's financially optimal replacement date 92A and the unmonetizable risk replacement date 92B (if any). In cases where the unmonetizable risk replacement date is earlier than the financially optimal replacement date, the optimal replacement date is determined by the need to replace the asset before an unacceptable risk of unmonetizable failure arises. In cases where the financially optimal replacement date is earlier than the unmonetizable risk replacement date, the optimal replacement date is determined by the desire to replace the asset at a time that achieves lowest total cost.

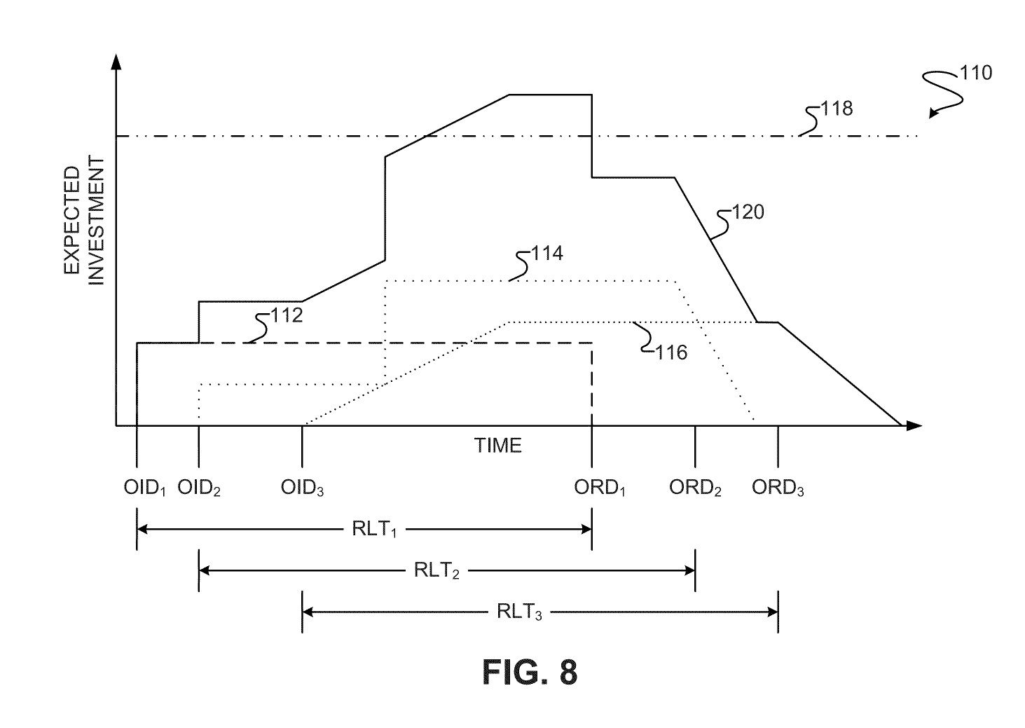

FIG. 8 is a graph 110 that graphically illustrates an example optimal investment schedule, such as may be determined in step 92. Graph 110 has three curves 112, 114 and 116 that each represent the investment over time expected for replacing a respective one of the three assets. Replacement investment curves 112, 114 and 116 start at the time when investment in the replacement of their respectively associated assets must begin in order for the replacement to be complete at the corresponding optimal replacement dates. The time when replacement investment must start in order to meet the optimal replacement date may be referred to herein as the “optimal investment date” for convenience. Replacement investment information 92C may comprise functions that express expected investment as a function of time (e.g., functions that when plotted yield curves like curves 112, 114 and 116), for example. Replacement investment information 92C may specify, for a replacement of a given capital asset, a plurality of different functions that express expected investment as a function of time, each function corresponding to a different investment start date or replacement date.

The relationship between optimal replacement dates and optimal investment dates is shown graphically in graph 110. The optimal replacement dates of the three assets are marked on the horizontal (time) axis of graph 110: ORD₁ indicates the optimal replacement date of the first asset, ORD₂ indicates the optimal replacement date of the second asset; ORD₃ indicates the optimal replacement date of the third asset. The replacement lead time interval for each of the three assets is marked on graph 110 as RLT₁, RLT₂ and RLT₃. The optimal investment dates for each of the three assets are marked on the horizontal axis of graph 110: OID₁ indicates the optimal investment date of the first asset, ORD₂ indicates the optimal investment date of the second asset; ORD₃ indicates the optimal investment date of the third asset. It will be noted that replacement investment curves may be non-zero after the optimal replacement date (e.g., replacing an asset may cause costs to be incurred (and/or revenues to be realized) after the replacement asset is in place, such as, for example, de-commissioning of the replaced asset, sale of the replaced asset (or components thereof), remediation of environmental damage caused by the replaced asset, for example).

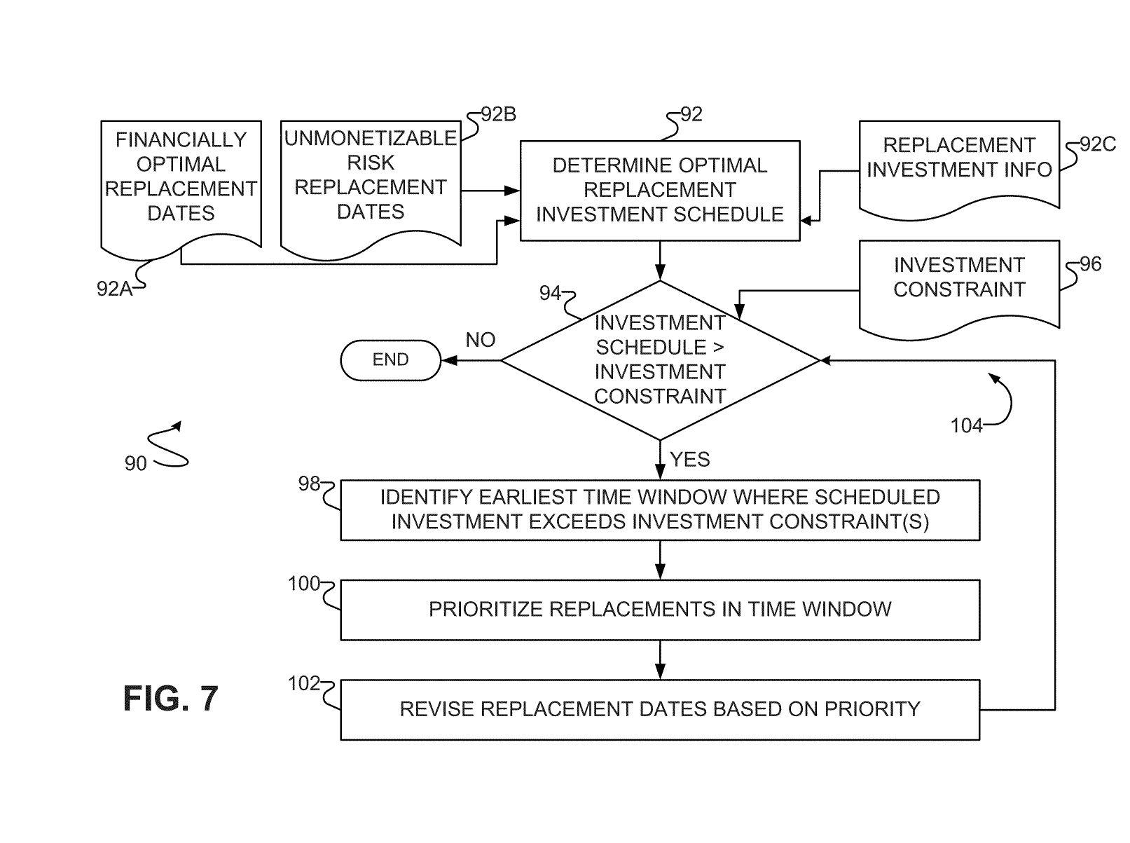

Returning to FIG. 7 and method 90, step 94 comprises determining if the optimal replacement investment schedule determined in step 92 exceeds an investment constraint 96. An example investment constraint is illustrated as curve 118 in graph 110. In graph 110, total investment curve 120 indicates the total replacement investment required to replace the three assets corresponding to replacement investment curves 112, 114 and 116 at their respective optimal replacement dates. Total replacement investment curve 120 may be computed as the sum of replacement investment curves 112, 114 and 116, for example. Where total replacement investment curve 120 exceeds investment constraint curve 118, it is infeasible to carry out the replacement schedule dictated by the optimal replacement dates subject to the constraint indicated by investment constraint curve 118.

Returning to FIG. 7 and method 90, where it is infeasible to carry out the replacement schedule dictated by the optimal replacement dates (step 94 “YES”), method 90 proceeds to step 98. Step 98 comprises identifying the earliest time window in which expected investment specified by the replacement investment schedule exceeds investment constraint 96. In some embodiments, a time window identified in step 98 comprises a single unit of time of pre-determined length over which expected investment specified by the replacement investment schedule considered in step 94 exceeds investment constraint 96. For example, a time window may comprise a single unit of time corresponding to the resolution of the replacement investment curve (e.g., a week, month, quarter, year, etc.).

In some embodiments, method 90 is performed separately for a plurality of time windows (e.g., consecutive time windows), and step 94 comprises determining whether the investment schedule in the relevant time window exceeds the investment constraint(s) for that window. In such embodiments, step 98 is unnecessary.

In some embodiments, a time window identified in step 98 comprises a plurality of time units corresponding to the resolution of the investment schedule. For example a time window identified in step 98 may comprise a plurality of consecutive time units in which expected investment specified by the replacement investment schedule exceeds the investment constraint 96, and which is bookended by time units in which expected investment specified by the replacement investment schedule does not exceed investment constraint 96.

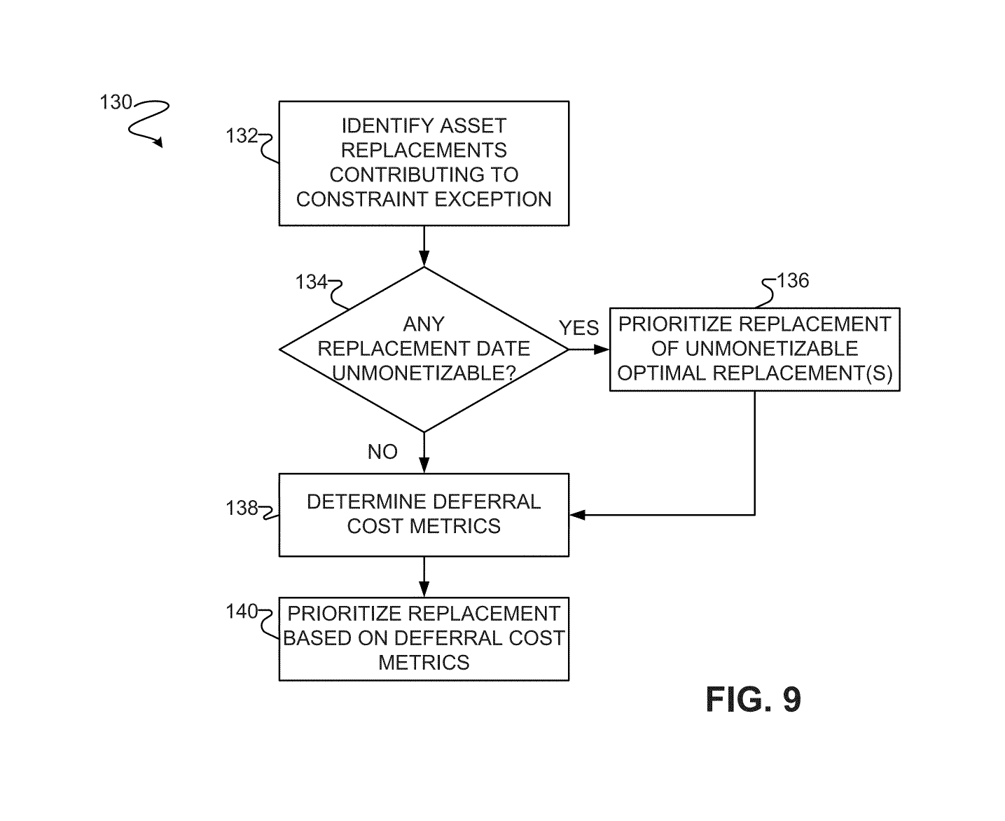

Step 100 comprises, for the time window identified in step 98, prioritizing deferral of asset replacement investments that, on the current replacement schedule, contribute to the replacement investment curve exceeding the investment constraint in the time window. FIG. 9 is a flowchart of a method 130 for prioritizing deferral of asset replacements according to an example embodiment. In method 130, step 132 comprises identifying the asset replacement investments that, on the current replacement schedule, contribute to the replacement investment curve exceeding the investment constraint in the time window. Step 132 may comprise identifying asset replacement investments that are non-zero in the time window, for example. In some embodiments, step 132 comprises identifying only asset replacement investments that begin in the time window.

Step 134 comprises determining whether any of the replacement dates corresponding to the asset replacement investments identified in step 132 are dictated by an unacceptable risk of unmonetizable failure. If any of the replacement dates corresponding to the asset replacement investments identified in step 132 are dictated by an unacceptable risk of unmonetizable failure (step 134 “YES”), then in step 136, these asset replacement investments are prioritized for replacement at their unmonetizable risk replacement dates. Prioritizing an asset for replacement at its unmonetizable risk replacement date may comprise removing the asset from consideration for deferral.

In some embodiments, once an asset is removed from consideration for deferral, it is thereafter not considered in subsequent iterations of method 130. For example, for a particular time window where the replacement investment curve exceeds the investment constraint, step 132 may be performed only on the first iteration of method 130, and subsequent iterations of method 130 may begin in step 138. It will be appreciated that steps 132, 134 and 136 may be combined (e.g., as a single step comprising identifying the asset replacement investments that (i) on the current replacement schedule contribute to the replacement investment curve exceeding the investment constraint in the time window and (ii) are not dictated by an unacceptable risk of unmonetizable failure.

After step 136, or after step 134 if none of the replacement dates corresponding to the asset replacement investments identified in step 132 are dictated by an unacceptable risk of unmonetizable failure (step 134 “NO”), method 130 proceeds to step 138. Step 138 comprises determining a replacement deferral cost metric for each of the asset replacements whose replacement dates are not dictated by an unacceptable risk of unmonetizable failure (i.e., asset replacements not prioritized in step 136). Non-limiting examples of replacement deferral cost metrics include:
the forward slope of the corresponding total cost curve, measured from the optimal replacement date (i.e., ratio of the incremental cost of deferral (rise) to the length of deferral (run));
the ratio of the incremental cost of a proposed deferral (e.g., by one or more unit lengths of time) to the total cost for the currently scheduled replacement date (e.g., the total cost indicated by the total cost curve for the currently scheduled replacement date); and
the like.
   Deferral cost metrics other than the examples set out above may be used.

In some embodiments, forward slopes of total cost curves computed in step 138 may be computed over the length of the time window identified in step 98. This may be done, for example, in embodiments where the time window identified in step 98 comprises a single unit of time corresponding to the resolution of the replacement investment curve (e.g. one week, one month, one quarter, one year or the like). In some embodiments, forward slopes of total cost curves computed in step 138 may be computed over length of time shorter than the length of the time window identified in step 100.

Step 140 comprises prioritizing asset replacements whose replacement dates are not dictated by an unacceptable risk of unmonetizable failure based on the deferral cost metrics determined in step 138. In some embodiments, step 140 comprises ranking the asset replacements whose replacement dates are not dictated by an unacceptable risk of unmonetizable failure according to the deferral cost metrics determined in step 138. Step 140 may comprise prioritizing asset replacements that are relatively less costly to defer more highly for deferral (conversely, less highly for scheduling replacement near the optimal replacement date) and prioritizing asset replacements that are relatively more costly to defer less highly for deferral (conversely, more highly for scheduling replacement near the optimal replacement date). In some embodiments, step 138 also takes into consideration the effect of deferral of an asset replacement on a system metric such that replacements that tend to have the largest effect on improving a system metric (e.g. an overall measure of reliability, an overall measure of efficiency, an overall measure of environmental responsibility or the like) are prioritized less highly for deferral while replacements that have smaller effects on improving the system metric are prioritized more highly for deferral.

In an example embodiment, step 140 comprises ranking the asset replacements according to a total replacement cost curve slope determined in step 138. Where this is done, asset replacements corresponding to relatively lower slopes (less increased cost per unit of deferral) are more highly prioritized for deferral (conversely, less highly prioritized for scheduling replacement near the optimal replacement date) and asset replacements corresponding to relatively higher slopes (greater increased cost per unit of deferral) are less highly prioritized for deferral (conversely, more highly prioritized for scheduling replacement near the optimal replacement date).

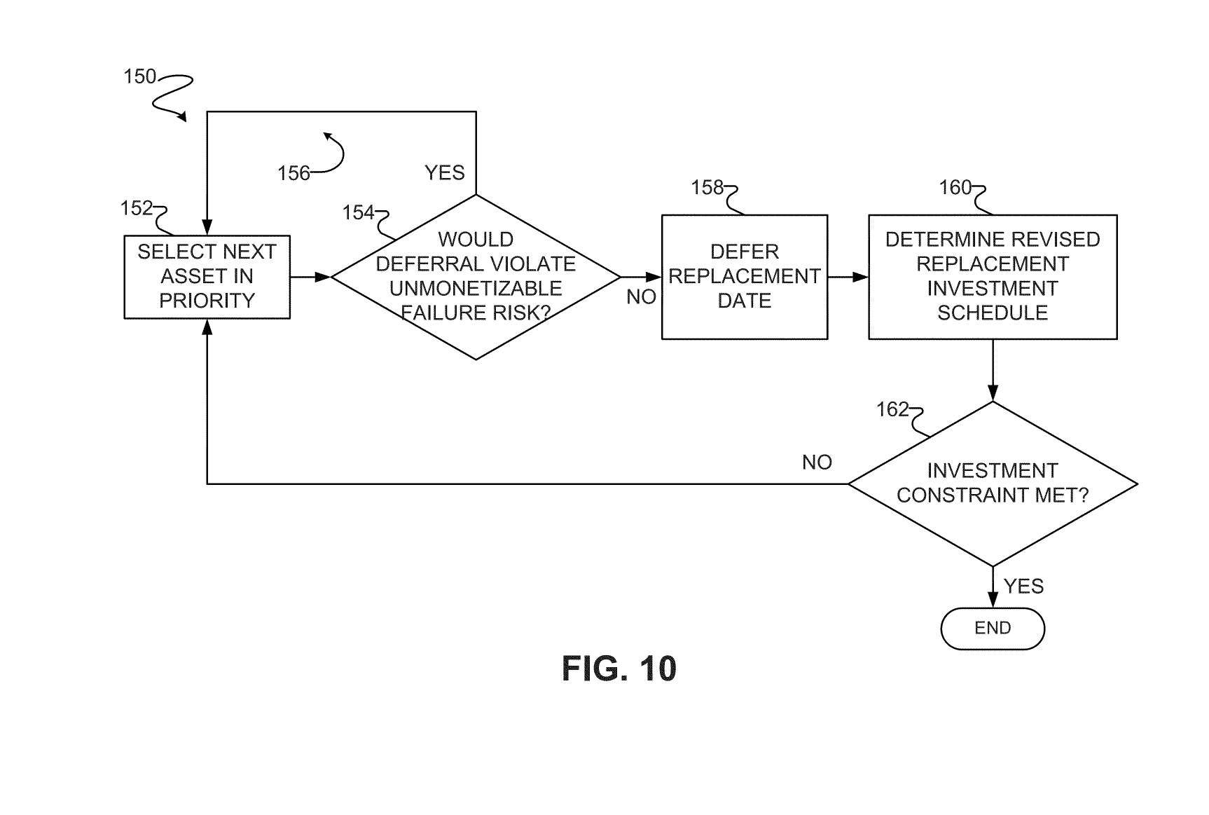

Returning to FIG. 7 and method 90, after step 100, method 90 proceeds to step 102. Step 102 comprises revising replacement dates based on the priorities determined in step 100. FIG. 10 is a flowchart of a method 150 for revising replacement dates according to an example embodiment. In method 150, step 152 comprises selecting the next highest deferral priority asset replacement for deferral (i.e., at the start of method 150, the asset replacement prioritized most highly for deferral).

Step 154 comprises determining whether deferring replacement of the asset by the length of the relevant time window would create an unacceptable risk of unmonetizable failure. Step 154 may comprise, for example, comparing a prospective deferred replacement date to a predetermined earliest date of unacceptable risk of unmonetizable failure (e.g., as determined in step 84 of method 80). If deferral of replacement of the asset would create an unacceptable risk of unmonetizable failure risk (step 154, “YES”), then method 150 proceeds to step 152 and the next highest deferral priority asset replacement is selected for a subsequent iteration of loop 156.

If deferral of replacement of the asset by the length of the relevant time window would not create an unacceptable risk of unmonetizable failure risk (step 154, “NO”), then method 150 proceeds to step 158. Step 158 comprises deferring the replacement date for the asset by the length of the relevant time window, and method 150 proceeds to step 160.

The step 154 determination of whether deferring replacement of the asset by the length of the relevant time window would create an unacceptable risk of unmonetizable failure may make the step 134 determination of whether replacement dates are dictated by an unacceptable risk of unmonetizable failure redundant. In some embodiments, method 130 does not include step 134 and all replacement identified in step 132 are prioritized in step 140.

Step 160 comprises determining a revised replacement investment schedule, at least for the relevant time window, based on the deferred replacement date of step 158. Step 160 may comprise, for example, determining a difference between the revised replacement investment curve for the asset replacement and a previously determined replacement investment curve for the asset replacement (such as the optimal replacement investment curve or a replacement investment curve determined in a previous iteration of step 160, for example), and adding the difference to the optimal replacement investment schedule. After step 160, method 150 proceeds to step 162.

Step 162 comprises determining whether the revised replacement investment schedule (i.e., the replacement investment schedule reflecting the revised replacement date set in step 158) meets the investment constraint in the relevant time window. If the revised replacement investment schedule does not meet the investment constraint in the relevant time window (step 160 “NO”), method 150 proceeds to step 152, and method 150 is repeated for the next asset in priority for deferral.

It will be appreciated that method 150 defers replacement of the highest deferral priority asset unless an unacceptable risk of unmonetizable failure would be created, and continues to defer assets in order of deferral priority until the spending constraint is met for the relevant time window. Where method 150 is applied to consecutive time windows that each comprise a single unit of time corresponding to the resolution of the replacement investment curve (e.g., multiple iterations of loop 104), the lowest replacement deferral cost is achieved for each time window. A total replacement investment curve 120 may be displayed and/or stored at the completion of method 150 and/or for intermediate schedules produced prior to completion of method 150. Such curves may be useful for budgeting purposes.

The method as described above may be used to create a schedule that is compatible with one or more resource-availability constraints instead of, or in addition to, the budgetary constraints discussed above. In some embodiments the method is repeated for each of a plurality of different constraints. For example, the method may comprise: determining a schedule based on financially optimal replacement dates for a plurality of capital assets (optionally also taking into account unmonetizable risk replacement dates for the assets); the schedule may then be made consistent with a first constraint (e.g. by identifying time periods wherein the first constraint would be exceeded according to the schedule) and selectively deferring replacement of one or more of the assets; the schedule may then be made consistent with a second constraint in the same manner; the schedule may optionally be made consistent with additional constraints by processing the schedule serially according to the additional constraints.

To simplify asset management, assets having similar characteristics may be pooled together for purposes of scheduling their replacements. Pooling of assets may be advantageous where it is more sensible to generalize characteristics of the pooled assets rather than obtain accurate information about each asset individually. For example, an electric utility may pool together all wood power poles installed in a particular climactic region within a particular time window (e.g., calendar year, etc.), and generalize the condition of these power poles (e.g., based on the condition ascertained for a sample of them by inspection, based on historical data for conditions of poles installed in the same region, etc.).

It may occur that an investment constraint prevents replacement of a group of pooled assets at a currently scheduled replacement date (e.g., the optimal replacement date). Where this occurs, it may be possible to satisfy the operative investment constraint by deferring replacement of only a portion of the assets in the pool. Where it is cost efficient to replace the assets at their currently scheduled replacement date as opposed to a later date, it may be preferable to defer replacement of only the portion of the assets necessary to meet the spending constraint and replace the remaining portion of the assets at the currently scheduled replacement date.

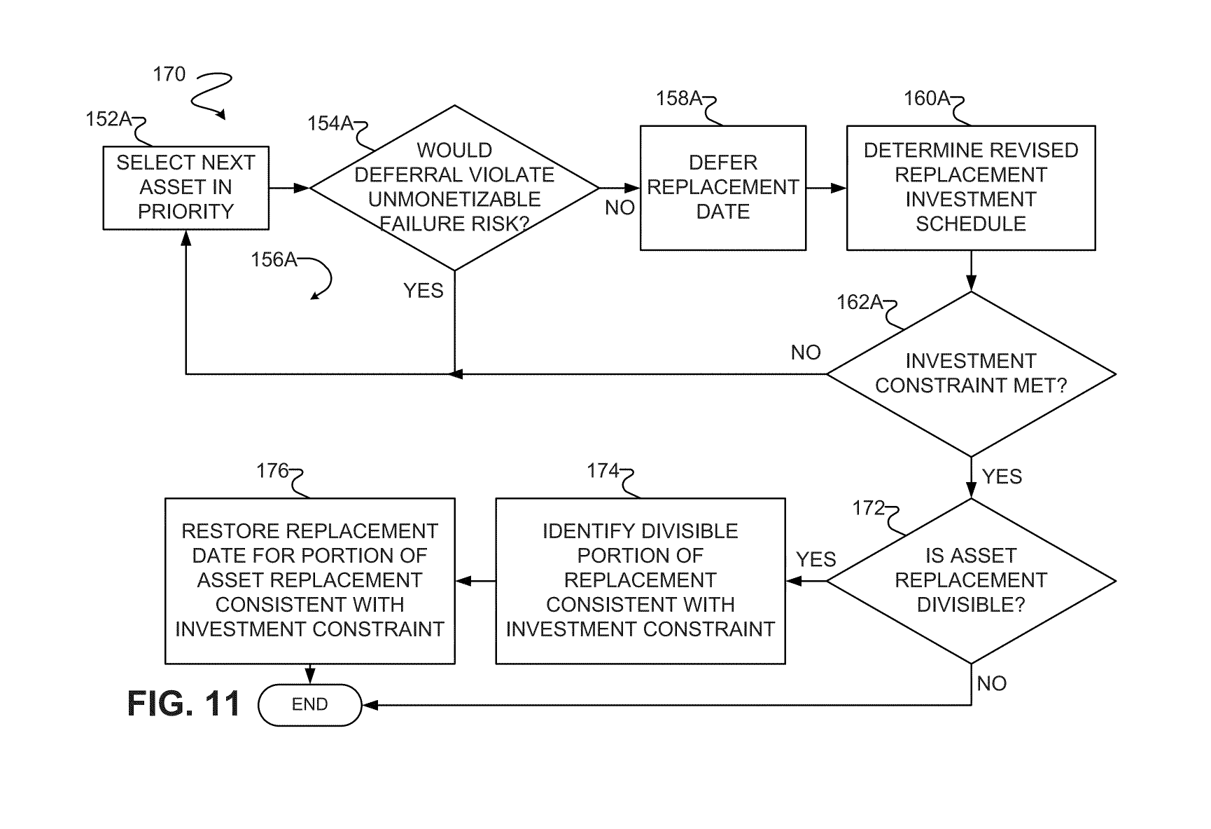

FIG. 11 is a flow chart of a method 170 for revising replacement dates according to an example embodiment. Steps of method 170 that are similar to those of method 150 are identified with like reference numerals distinguished by the suffix “A” and are not described again here. Method 170 may achieve improved cost efficiency where at least some assets are pooled for replacement.

In method 170, if it is determined in step 162A that the deferral in step 158A of the replacement date of an asset has resulted in a revised replacement investment schedule that meets the spending constraint (step 162A, “YES”), method 170 proceeds to step 172. Step 172 comprises determining whether the asset replacement investment corresponding to the asset replacement deferred in step 158A is divisible. If the asset replacement investment corresponding to the asset replacement deferred in step 158A is divisible (step 172, “YES”), method 170 proceeds to step 174.

Step 174 comprises determining a divisible portion of the asset replacement deferred in step 158A that does not need to be deferred in order meet the investment constraint. A divisible asset replacement may or may not be continuously divisible. It may occur that a divisible asset replacement cannot be divided into a portion that is sufficiently small to be accommodated within the investment constraint for the relevant time window. A divisible asset may be divisible in terms of quantity of component assets or parts (e.g., individual power poles, etc.) and/or may be divisible in other terms associated with investment constraints (e.g., payment of a lease required to begin construction, allocation of a key employee's time, etc.).

Step 176 comprises restoring the replacement date for the portion of the asset replacement identified in step 174 (i.e., the divisible portion of the asset replacement deferred in step 158A that does not need to be deferred in order meet the investment constraint).

It may occur that dividing a divisible asset causes one or more cost curves for the deferred portion of the asset replacement to change. In some embodiments, when a divisible asset replacement is divided to meet an investment constraint, the portion of the in-place asset whose replacement is deferred is treated as a new in-place capital asset for subsequent replacement scheduling. This may entail determining a new total cost function for the portion of the in-place asset whose replacement was deferred.

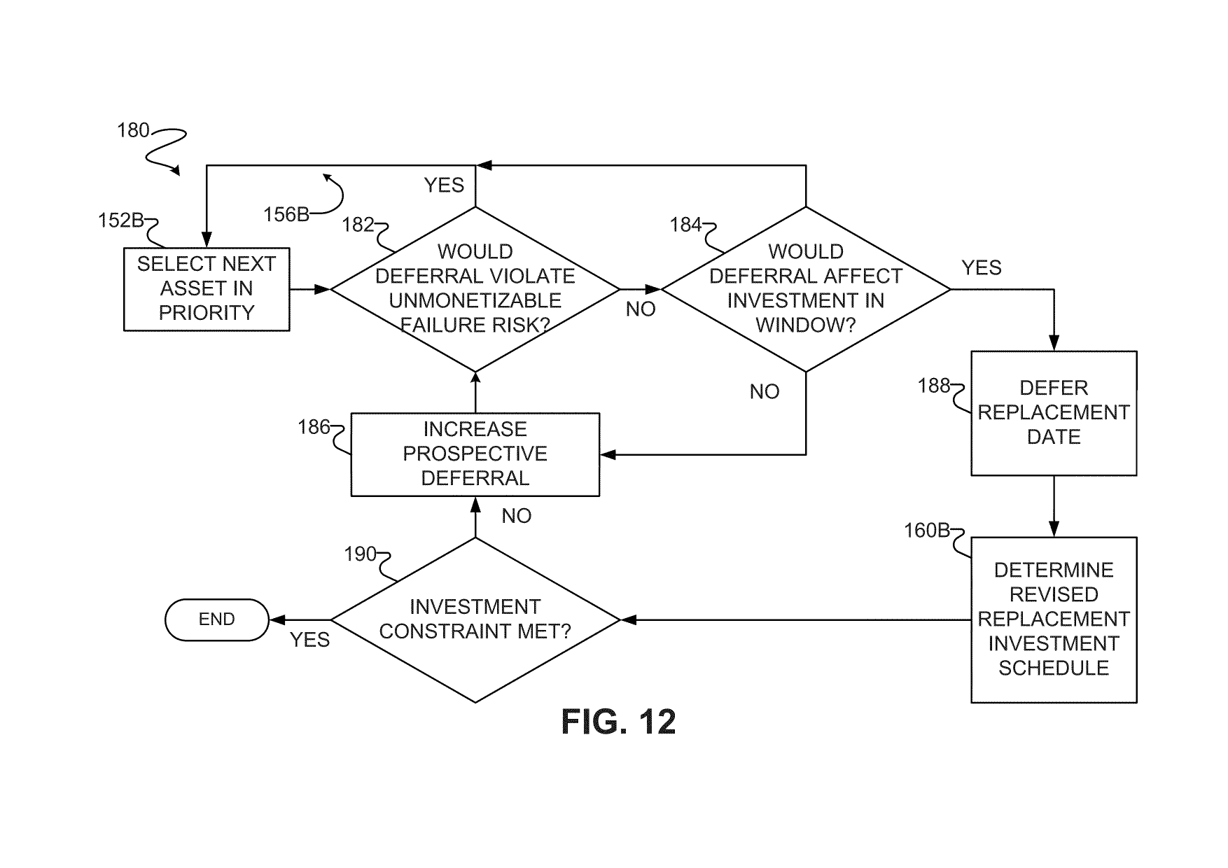

FIG. 12 is a flowchart of a method 180 for revising replacement dates according to another example embodiment. Steps of method 180 that are similar to those of method 150 are identified with like reference numerals distinguished by the suffix “B” and are not described again here. Method 180 may be applied to time windows that comprise a plurality of time units corresponding to the resolution of the investment schedule.

In method 180, step 182 comprises determining whether deferring the replacement date of an asset by a prospective incremental deferral shorter than the relevant time window would create an unacceptable risk of unmonetizable failure. Step 182 may comprise, for example, comparing a prospective deferred replacement date to a predetermined earliest date of unacceptable risk of unmonetizable failure (e.g., as determined in step 84 of method 80). If the prospective incremental deferral of replacement of the asset would create an unacceptable risk of unmonetizable failure risk (step 182, “YES”), then method 180 proceeds to step 152B and the next highest deferral priority asset replacement is selected for a subsequent iteration of loop 156B.

If deferral of replacement of the asset would not create an unacceptable risk of unmonetizable failure risk (step 182, “NO”), then method 180 proceeds to step 184. Step 184 comprises determining whether the incremental deferral of replacement of the asset would affect the total replacement investment curve in the relevant window. Step 184 may comprise determining whether the incremental deferral introduces a portion of the replacement investment curve for the asset replacement having positive slope into the relevant time window, for example.

If the incremental deferral of replacement of the asset would not affect the total replacement investment curve in the relevant window (step 184, “NO”), method 180 proceeds to step 186. In step 186, the prospective incremental deferral is increased (e.g., incrementally), and method 180 returns to step 182. By the loop formed by steps 182, 184 and 186, the minimum asset replacement date deferral that will reduce the total replacement investment curve in the relevant window without causing an unacceptable risk of unmonetizable failure is determined. It will be appreciated that steps 182, 184 and 186 may be combined (e.g., into a single step of determining the minimum replacement deferral, if any, that reduces the total replacement investment curve in the relevant window without causing an unacceptable risk of unmonetizable failure).

If deferral of replacement of the asset would affect the total replacement investment curve in the relevant window (step 184, “YES”), method 180 proceeds to step 188. In step 188, the replacement date for the asset is deferred by the amount of the prospective incremental deferral, and method 180 proceeds to step 160B, and then step 190.

Step 190 comprises determining whether the revised replacement investment schedule (i.e., the replacement investment schedule reflecting the revised replacement date set in step 188) meets the investment constraint in the relevant time window. If the revised replacement investment schedule does not meet the investment constraint in the relevant time window (step 190 “NO”), method 180 proceeds to step 186, and it is subsequently determined if the total replacement investment curve in the relevant window can be reduced by further deferral of the asset replacement without causing an unacceptable risk of unmonetizable failure.

It will be appreciated that method 180 defers replacement of the highest deferral priority asset until either (i) an unacceptable risk of unmonetizable failure would be created, (ii) the replacement investment curve for the asset is zero in the window (e.g., replacement of the asset has been deferred sufficiently long that none of the investment required for the asset remains in the window), or (iii) the spending constraint is met for the relevant time window. It will be further appreciated that method 160 only defers replacement of an asset next in deferral priority asset if condition (i) or (ii) occurs. In some embodiments, method 180 includes steps analogous to steps 172, 174 and 176 of method 170.

Returning to FIG. 7 and method 90, after step 102, method 90 returns to step 94. In step 94, it is determined whether the current replacement investment schedule (e.g., as modified by deferral of replacement dates in step 102) exceeds investment constraint 96. It will be appreciated that consecutive iterations of loop 104, there may be different time windows where it is infeasible to achieve the current replacement schedule. For example, deferral of replacement dates in step 102 may resolve one investment constraint exception but create a new, later investment constraint exception.

Apparatus and methods as described herein may be used to create schedules that extend far enough into the future that the schedule will include both replacement of an asset and replacement of the replacement for the asset. Thus, the schedules may include a chain of scheduled investments in the same asset. In such cases, the financially optimum dates for later-made investments and the unmonetizable risk replacement dates for later-made investments may depend on the dates of earlier replacements (e.g. if an earlier replacement is deferred then the financially optimum dates for subsequent replacements and the unmontetizable risk dates for subsequent replacements may also be later). Such cases may be handled in various ways. In some embodiments, scheduling is not performed for subsequent replacements of an asset until the scheduling has been done for earlier replacements of the asset (i.e. initial scheduling is broken into sections each covering a time period so that two replacements for the same asset do not occur in the period being scheduled at any one time). In such embodiments, a cost curve for a subsequent replacement may be generated based in part on the date scheduled for replacing the in-place capital asset. The later replacement may be scheduled using this cost curve.

In other embodiments, a total cost curve for an asset may be determined in a manner that takes into considerations all of the future replacements for the asset as well as an assumed temporal relationship between the future replacements (e.g. for a certain type of asset it may be assumed that the asset will require replacement every 7 years). In such embodiments, scheduling replacement of an in-place capital asset may automatically schedule one or more subsequent replacements for the replacement for the in-place capital asset. Other options may also be provided.

As noted above, the terms ‘replace’ and ‘replacement’, as used herein include significant maintenance, refurbishing and upgrading assets in addition to complete removal and replacement of the assets with other assets. As such, the systems and methods described herein may be used to schedule significant investments over the entire lifespan of an asset. For example, the lifespans of some assets may be increased by refurbishing the asset one or more times. An example, of this is a generator that may be refurbished one or more times (e.g. three times) in place before it requires replacement. In such cases, the refurbishments of the asset may be scheduled as described above. The change in condition of the asset as a result of the refurbishment(s) may be included in the total cost function for the asset. If the period for which a schedule is being developed is long enough then the eventual complete replacement of the asset may also be scheduled. In some embodiments, the period for which a schedule is being developed may be in excess of 8 years. The period may be 50 years or longer in some embodiments. In such a period, certain in-place capital assets may require replacement one, two, three, four or more times. Some embodiments of the invention may model such in-place capital assets and perform scheduling of multiple replacements for the assets according to the principles described herein.

As mentioned above, a lost advantage cost curve may include consideration of the expected cost of an in-place asset's inability to meet demand, which demand could be met by a replacement asset having greater capacity. Such consideration may be used to schedule upgrades of in-place assets (e.g., replacement of an in-place asset with an asset having greater capacity to meet demand, replacement of an in-place asset with a plurality of assets that meet the same demand, etc.). These considerations may be embodied, for example, in unmet demand curves, which reflect the difference between the capacity of an in-place asset or replacement (upgrade) asset and the forecast demand for capacity served by the in-place asset or replacement asset.

Demand for a particular capacity may be forecast based on current demand for the capacity and projected growth of a proxy for demand (e.g., gross domestic product, population, etc.). For example, an unmet demand curve for an in-place electrical substation transformer having capacity of 6 MVA may be determined based on the current demand on the transformer's capacity and the forecast that this demand is expected to increase at the rate of growth of the economy. A corresponding unmet demand curve for a replacement electrical substation transformer having capacity of 12 MVA may be similarly determined, and the difference between the two unmet demand curves factored into a lost cost advantage curve

Increasing demands for capacity can also be met by installing new capital assets (i.e., assets that are in addition to and do not replace in-place assets). It is desirable to schedule investment in new capital assets cost efficiently. This may be done by treating a new capital asset as the replacement of a null in-place asset. In an example of such treatment, the replacement deferral risk cost curve is null (there being no failure deferral risk for not replacing a null asset), the lost cost advantage curve indicates the relative cost advantage of not operating the new asset (i.e., operating a null asset) versus operating the new asset, and the replacement cost curve indicates only costs associated with installing the new asset (there being no costs associated with disposal of a null asset). The lost advantage cost curve may reflect forecast demand for capacity that would be served by the new asset. A total cost curve may thus be generated for a new asset based only on a use cost curve for the new asset and the replacement cost curve.

An unmonetizable failure risk date may be stipulated for a new asset, for example to reflect business or political imperatives.

As an alternative to scheduling installation of specific new assets, growth required to meet increasing demand may treated as a pre-emptive claim on an organization's investment capacity and factored into investment constraints imposed on investment scheduling. The growth required to meet increasing demand may be based on current capacity to meet a demand and projected growth of a proxy for that demand (e.g., gross domestic product, population, etc.).

In some embodiments replacement assets scheduled for installation to replace an in-place asset (or new assets scheduled for installation, such as to meet growth in demand, etc.) may themselves be scheduled for later replacement. For example, if a presently in-place capital asset is scheduled to be replaced with a replacement capital asset in a first time window, the replacement asset may be scheduled to be replaced with a further replacement capital asset in a second, later, time window. In some embodiments, when replacement of an in-place asset with a replacement asset is scheduled, a new notional in-place capital asset is added to the collection of assets whose replacement is to be scheduled to represent the replacement asset. A total cost curve may be determined for the new notional in-place capital and its replacement scheduled in the same fashion as any other in-place asset. In other embodiments, both in-place assets and their replacements (and, optionally, the replacements' replacements, and so on) are included in a collection of assets whose replacement is to be scheduled. In some such embodiments, the total cost curve for each replacement asset is determined after the scheduled replacement date of its antecedent asset is no longer eligible for deferral. In other such embodiments, the total cost curve for each replacement asset is determined whenever the scheduled replacement date of its antecedent asset changes.

In some embodiments, investments required to replace yet-to-be installed assets (e.g., replacement assets that replace in-place assets or new assets scheduled for future installation) are forecast without scheduling the replacements of the replacement assets. For example, in some embodiments, the investment required for future replacement(s) of a yet-to-be installed asset is forecast based on an expected end of life of the yet-to-be installed asset (e.g., end of life as determined based on typical lifespan from installation to planned replacement and/or unanticipated failure). Such forecast investments may be totaled to provide a forecast of future investment demands.

In some embodiments, there can be cost efficiencies associated with replacing different assets at about the same time. For example, a large piece of equipment may be needed to replace an asset at a remote location. Moving the equipment on-site may be a significant proportion of the cost of replacing the asset. If the equipment can be used to replace one or more assets while it is on-site then the cost for replacing the other asset(s) may be significantly reduced. Some embodiments account for these potential savings in making scheduling decisions. This may be done, for example, by providing a plurality of models for an asset. The plurality of models may include a model where the asset is replaced without reference to other assets and a model where the asset is replaced in conjunction with another asset. Replacement of the assets may be prioritized using both models and then one of the plurality of models may be applied based on the prioritizations.

Some embodiments provide methods which apply rules that specify relationships between assets. For example, such rules may specify things such as: if one asset is replaced then one or more other assets should be replaced at the same time; if one asset is being replaced then do not schedule replacement of another asset such that replacement of the two assets overlap; or ensure that assets A and B are replaced in a particular order (e.g. A first and then B).

An example embodiment provides a rules database that includes rules relating to replacement of a plurality of assets. In such embodiments, methods as described above may be modified to retrieve the rules from the rules database and to apply the rules in scheduling the replacement of the assets. For example, where the rules include one or more rules that specify that a plurality of assets should be replaced at one time (or as part of a project in which the plurality of assets are to be replaced in a specified sequence and/or at specified times relative to one another) then the plurality of assets may be treated as a single combined asset having cost functions obtained by combining cost functions for the individual assets (the individual cost functions taking into account the fact that the plurality of assets are to be replaced together). The earliest unmonetizable risk date for any of the individual assets in the plurality of assets may be used as the unmonetizable risk date for the combined asset. As another example, where the rules include one or more rules that specify that two assets should not be scheduled for replacement at the same time then methods as described herein may check the rules at the time an asset is being scheduled to ensure compliance with the rules. As an alternative, a check may be performed after a schedule has been completed to ensure that the schedule does not break any rules that require different assets to be replaced at different times.

In some embodiments, systems and methods as described herein may be configured to estimate metrics associated with a system of capital assets being maintained. For example, a metric of overall reliability for the system may be estimated based on the condition of and associated risk of failure of the capital assets as well as modeled consequences of failure of the capital assets. For example, where the capital assets are components of a utility (e.g. an electrical utility) then measures such as System Average Interruption Duration Index (SAIDI) or System Average Interruption Frequency Index (SAIFI) or Equivalent Forced Outage Rate (EFOR). Other metrics may be associated with production (for example, it may be necessary to maintain production above a minimum value). Such metrics may be used as additional constraints for scheduling maintenance (including replacement, refurbishing, major maintenance etc.) of capital assets. In some embodiments, systems and methods according to the invention are configured to provide reports that include estimates of such system metrics.

In some embodiments, systems and methods as described herein include checks to determine whether deferring replacement of a capital asset would result in a system metric failing to satisfy a rule (e.g. production capacity must always at least equal a minimum threshold value or a system reliability metric should always have at least a minimum threshold value). In some cases, the check is performed in conjunction with determining whether to defer replacement of a capital asset in order to satisfy an investment constraint or another resource constraint. If the check indicates that deferral of the replacement would result in the system metric failing to satisfy the rule then the system may schedule replacement of the capital asset without deferment.

In some embodiments, the effect of failure of one or more capital assets on a system metric is modeled and included in a replacement deferral risk cost model. Where failure of the asset would cause the system metric to be changed in an undesirable direction (e.g. lower system reliability, lower minimum production capacity etc.) then a cost may be added to the replacement deferral risk cost model. The added cost may be in proportion to the degree that failure of the asset would affect the system metric in question.

In general, results of methods 50, 70, 80, 90, 130, 150, 170 and 180 may depend on present information and future expectations. For instance,
cost functions obtained or determined in method 50 may depend on future expectations concerning future interest rates, prices of inputs (such as materials and labour, for example), prices for goods or services produced or delivered by or with assets (e.g., spot prices for sale of electric energy, etc.), prices for goods or services which must be purchased to make up for lost production of a failed asset (e.g., spot prices for purchase of electric energy, etc.), advances in technology (such as may affect the productivity of replacement assets), and the like;
probabilities of failure determined in methods 50 and 80 may depend on future expectations concerning future advances in maintenance, testing and the like;
unmonetizable failure probability thresholds in method 80 may depend on future expectations concerning future public tolerance for particular failure events;
replacement investment schedules determined in method 90 may depend on future expectations concerning the replacement costs (e.g., replacement investment curves may reflect assumptions about interest rates, capital costs, technology advances, etc.), and
investment constraints in method 90 may depend on future expectations concerning future availability of resources.

A variety of such present information and future expectations may be implicit and/or explicit in input parameters 44 to automated tool 30. Replacement dates obtained using methods 70 and 80, and corresponding investment schedules obtained using method 90, may be affected by the quality of the present information and future expectations. Since expectations about the future may be the subject of debate, it may be advantageous to determine a plurality of replacement schedules using a plurality of different future expectations.

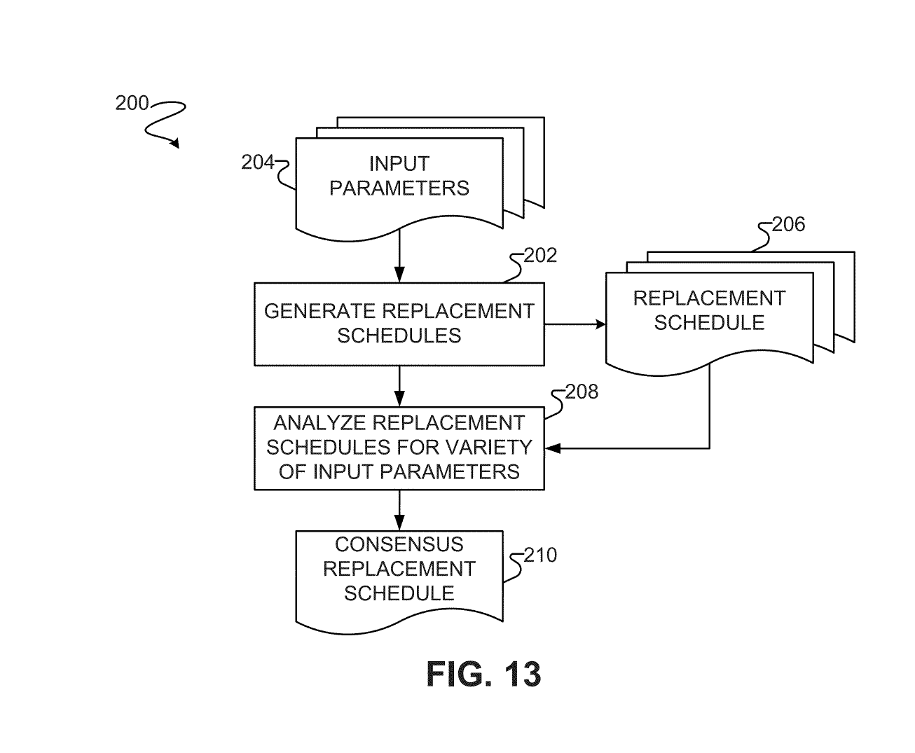

FIG. 13 is a flowchart of method 200 for determining a replacement schedule according to an example embodiment. In step 202 of method 200, a plurality of capital asset replacement schedules 206 are generated based on corresponding plurality of different sets of input parameters 204. A set of input parameters 204 may comprise replacement deferral cost information 52B, in-place asset use cost information 54B, replacement asset use cost information 56B, replacement cost information 60B, unmonetizable failure probability information 82B, replacement investment information 92C, investment constraint 96, and the like, for example. In some embodiments, certain parameters are common to models for a plurality of asset types. Examples of such parameters include expected inflation rate, expected discount rate, expected price for an output (e.g. expected future prices for electricity) and so on. Such parameters may be called “global parameters”. Other parameters may be specific to individual assets or asset types. Capital asset replacement schedules 206 may pertain to one capital asset or to a plurality of capital assets. Step 202 may comprise generating a capital asset replacement schedule using any suitable method, and may comprise all or any part of one or more of methods 50, 70, 80, 90, 110, 130, 170, 180, and 190, for example.

After step 202, method 200 proceeds to step 208. In step 208, the plurality of replacement schedules are analyzed with regard to the sets of input parameters 204 used in their generation to determine a consensus replacement schedule 210. In some embodiments, step 208 comprises performing a sensitivity analysis on the plurality of replacement schedules 208 and the correspondingly plurality of sets of input parameters 204. In some embodiments, step 208 comprises the application of human judgment.

In some embodiments, method 200 automatically generates replacement schedules for a plurality of different values for certain parameters. For example, method 200 may generate replacement schedules for a plurality of different future interest rate scenarios, a plurality of different future inflation scenarios, a plurality of different future energy cost scenarios, a plurality of different future scenarios for investment constraints and/or a plurality of different scenarios for demand for the output of the capital assets. In some embodiments, apparatus is configured to determine a plurality of different investment schedules each for a different combination of parameter values. The parameter values that differ between the investment schedules may comprise global parameters. The apparatus may automatically generate investment schedules for example for different values within a range for a global parameter indicative of projected future energy costs. In some embodiments the apparatus compares the investment schedules so produced and automatically marks assets for which replacement is scheduled at markedly different times as among the different investment schedules. Marked assets may be highlighted in a report, listed in a separate report, or otherwise highlighted for the attention of a user.

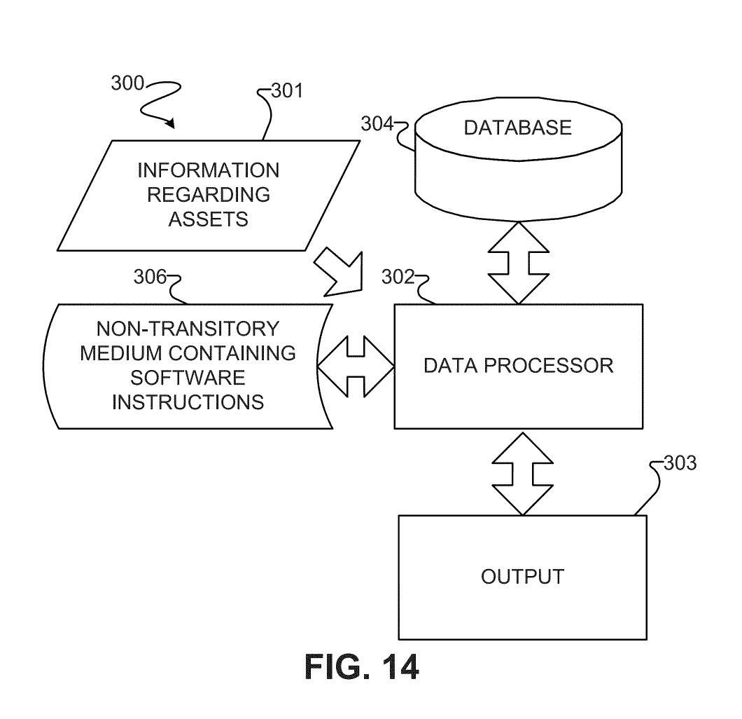

FIG. 14 is a schematic diagram of an apparatus 300 according to an example embodiment. Apparatus 300 comprises a data processor 302 and a database 304 accessible to data processor 300. Database 304 stores asset information for each of a plurality of in-place capital assets. Asset information stored in database 204 may comprise replacement deferral cost information 52B, in-place asset use cost information 54B, replacement asset use cost information 56B, replacement cost information 60B, unmonetizable failure probability information 82B, investment constraint 96, and the like, for example. The information may include, without limitations, information 301 regarding the physical condition of equipment or other capital assets.

Apparatus 300 also comprises a non-transitory medium 306 containing software instructions readable by data processor 302. The software instructions are configured to cause data processor 302 to execute one or more steps of methods 50, 70, 80, 90, 110, 130, 170, 180, and 190. For example the software instructions may be configured to cause data processor 302 to execute, for a plurality of different in-place capital assets, one or more of a replacement deferral cost model, an in-place asset use model, an replacement asset use model and replacement cost model, each with asset information from database 304 as input.

In some embodiments apparatus 300 comprises a plurality of pre-defined models. these may include replacement deferral cost models, in-place asset use models, replacement asset use models and replacement cost models for use in association with each of a plurality of types of asset. The predefined models may be used as templates to model specific in-place capital assets by supplying information about the in-place capital assets. The information may be stored in database 304 and accessed by the models, for example. The models may represent costs in financial terms and/or in terms of the estimated consumption of human and other resources of a variety of types. The predefined models may, in some cases, explicitly reference information specific to the costs associated with capital assets of the types to which the models relate. For example, a predefined model for the replacement cost of a generator may include costs associated with taking a generator off-line, transportation of equipment and personnel to the generator site, removal of the generator, transportation of a replacement generator, site preparation, installation of the replacement generator, and bringing the replacement generator on-line. These categories may be further subdivided into finer levels of detail.

In some embodiments, models associated with specific in-place assets are linked to icons on a graphical display showing an overall system in which the in-place assets exist.

Results are output (e.g. displayed and/or stored for subsequent use and/or provided to another automated system and/or output as a human-readable report) by an output device 303.

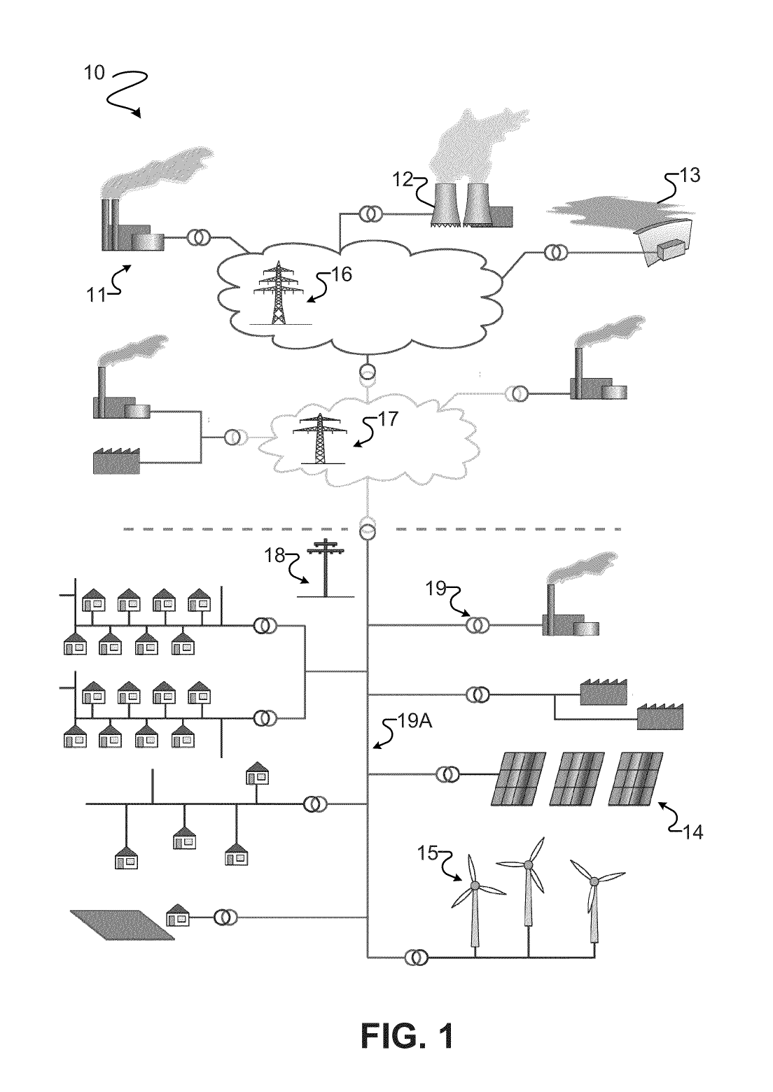

The following simplified example use case illustrates some aspects of the invention. An electric power utility has an annual financial budget for replacing assets 10 shown in FIG. 1, and component assets thereof. The management of the utility must determine how to cost-efficiently allocate this budget, while maintaining public safety.

Before allocating the budget, the management arranges for the condition of some of assets 10 to be determined by physical inspection of the assets. Hydroelectric generating station 13 is one of the assets inspected. The inspection of hydroelectric generating station 13 reveals that the probability that a particular one of its spillway gates failing in the next year is greater than a threshold. Failure of the spillway gate is judged by the management to be an unmonetizable risk, since one consequence of the spillway gate failing during spring runoff is catastrophic flooding of developed areas adjacent generating station 13.

Another of assets 10 inspected is one of wind turbines 15. Information gleaned from this inspection is combined with known failure modes of the turbine to determine probabilities that the turbine will experience various failures at different times in the future. These failure modes are associated with expected failure costs. Some failures of the wind turbine result in the loss of the ability to generate power, which would cause the utility to lose certain tax credits for generating “green” power. Wind turbines 15 are all located in the same geographic area, are of identical construction and approximately the same age, so management decides to use detailed inspection results for the one of wind turbines 15 (or for a few of wind turbines 15) as a representative of all wind turbines 15.

In addition to arranging for inspections of some of assets 10, management also obtains information about replacements for assets 10. This information includes replacement investment profiles for the replacements, as well as information from which lost advantage cost curves may be obtained. An example of this is solar panels 14. As a result of recent advances in solar panel technology, in-place solar panels 14 are considerably less efficient than their prospective replacements. As such, replacement of solar panels 14 is expected to yield significant near term cost advantages.

A sample of the low voltage power poles 18 is also inspected. Low voltage power poles 18 are relatively large in number, and the consequences of their individual failures relatively insignificant. Management determines that low voltage power poles will be treated as run-to-failure assets, and replaced on an individual basis when they fail (or are discovered to be in poor condition). Based on the condition of the sample of poles 18 inspected, a failure probability is estimated, and a portion of the budget set aside for the cost of replacing the poles 18 expected to fail in the budgeted year.

To prioritize allocations of its budget, management causes the above information, as well as other information (e.g., information about the operating costs of assets 10 possessed as a result of its internal fiscal management policies, etc.) to be entered into a database of an apparatus according to an embodiment of the invention. When information entry is complete, the database stores asset information for each of assets 10 and certain component assets thereof that includes at least: replacement deferral risk cost information, first use cost information related to use of the in-place asset, second use cost information related to use of the in-place asset's replacement, and replacement cost information. The database also stores investment constraint information that reflects both the replacement budget and the portion of the budget that is pre-allocated to replacing power poles 18 that are expected to fail in the budget year. The database may also store resource constraints for one or more resources. It is not mandatory that all of the information be in the same database. The database may comprise a plurality of information storage devices logically organized into a plurality of computer-accessible information repositories.

Management then causes a data processor of the apparatus to execute software instructions contained on a non-transitory medium, which cause the data processor to generate total cost curves for at least some of assets 10, including specifically the spillway gate of hydroelectric generating station 13, solar panels 14, and wind turbines 15.

The apparatus generates a report that includes a schedule of asset replacements in which the spillway gate of hydroelectric generating station 13 is replaced in the budget year, but solar panels 14 and wind turbines 15 are not replaced until subsequent years.

The report also includes a ranking of financially optimal replacements, according to which replacement of solar panels 14 ranks above both wind turbines 15 and the spillway gate of hydroelectric generating station 13. The report indicates that the scheduled replacement date for the spillway gate is an unmonetizable risk replacement date, so the management understands that this replacement cannot be deferred, even though its deferral might allow for more financially beneficial replacements to be schedule for the budget year. Management also receives reports indicating future expected costs for implementing replacement schedules. These reports may indicate future problems such as the possibility that a large number of assets may become scheduled for replacement in a future year such that it may become difficult to satisfy expected cost constraints without advance planning. The reports may provide many years advance warning of such situations so that management has time to plan to address the situations. The reports may include identification of resources required to execute the plan (e.g. by week, biweek, month or year). Such a resource outline can be very useful from a planning point-of-view and may provide advance warning of the need to add resources of various types (e.g. the report may indicate the need to add the capacity for 10,000 more hours of installation labor in 13 years' time. The reports may also include estimates of various system metrics such as minimum generation capacity and/or one or more system reliability indices as a function of time.

After the report is generated, management learns that due to an unexpected surge in the spot price of electrical power, its budget for replacing assets 10 has been enlarged. It also learns that the costs of replacing solar panels 14 is lower than previously determined due to a recent change in import tariffs. Management causes the database to be updated to reflect the changed investment constraint information (larger budget) and replacement cost information (lower cost to replace solar panels 13). Management causes a new report to be generated on the basis of the updated information. The new report includes a schedule of asset replacements in which both the spillway gate of hydroelectric generating station 13 and solar panels 14 are scheduled to be replaced in the budget year.

Though dates have been used as the measure of time in descriptions of embodiments herein, it will be appreciated that embodiments of the invention may use any measure of time (e.g., time may be measured as an offset from an arbitrary reference, time may be measured in larger or smaller units than days, etc.).

Though electric utility assets are used in explaining some aspects of the invention, it will be understood that these are non-limiting examples. Application of the invention is not limited to electric utility assets, or to assets of any other kind of utility. Aspects of the invention may be practiced with any type of capital assets, and by or for the benefit of any organization that invests in capital assets.

Where a component is referred to above (e.g., total cost curve generator, financial scheduler, unmonetizable risk scheduler, investment constrained scheduler, processor, database, non-transitory medium, software instructions, model, function, etc.), unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Where the context permits, words in the above description using the singular or plural number may also include the plural or singular number respectively. The word “or,” in reference to a list of two or more items, covers all of the following interpretations of the word: any of the items in the list, all of the items in the list, and any combination of the items in the list.

It is not practical to describe all possible applications. The above detailed description of examples of the technology is not intended to be exhaustive or to limit the system to the precise form disclosed above. While specific examples of, and examples for, the system are described above for illustrative purposes, various equivalent modifications are possible within the scope of the system, as those skilled in the relevant art will recognize. For example, while processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

Data processing steps as described above may be performed in hardware, software (including ‘firmware’) in combination with a data processor to execute the software or suitable combinations of hardware and software. Certain implementations of the invention comprise computer processors which execute software instructions which cause the processors to perform a method of the invention. For example, one or more processors in a workstation or the like may implement methods as described herein by executing software instructions in a program memory accessible to the processors. A data processor may comprise one or more microprocessors, math co-processors, digital signal processors or the like executing software and/or firmware instructions which cause the data processor to implement methods as described herein. The software and other modules described herein may be executed by a general-purpose computer, e.g., a server computer, financial management system, or personal computer. Furthermore, aspects of the system can be embodied in a special purpose computer or data processor that is specifically programmed, configured, or constructed to perform one or more of the computer-executable instructions explained in detail herein. Such methods may also be performed by logic circuits which may be hard configured or configurable (such as, for example logic circuits provided by a field-programmable gate array “FPGA”).

Those skilled in the relevant art will appreciate that aspects of the system can be practised with other communications, data processing, or computer system configurations, including: Internet appliances, cloud computing, multi-processor systems, microprocessor-based or programmable devices, network PCs, mini-computers, mainframe computers, and the like.

Software and other modules may be accessible via local memory, via a network, via a browser or other application in an ASP context, or via other means suitable for the purposes described herein. Examples of the technology can also be practised in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures (e.g., containers) described herein may comprise computer files, variables, programming arrays, programming structures, or any electronic information storage schemes or methods, or any combinations thereof, suitable for the purposes described herein.

The invention may also be provided in the form of a program product. The program product may comprise any non-transitory medium which carries a set of computer-readable signals comprising instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted. Computer instructions, data structures, and other data used in the practice of the technology may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Where a component (e.g. a model, processor, scheduler, display, data store, software module, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The technology provided herein can be applied to systems other than the example systems described above. The elements and acts of the various examples described above can be combined to provide further examples. For example, any feature described in relation to one embodiment described herein may be added to the features of any other embodiment described herein unless fundamentally incompatible therewith. Simpler embodiments may be arrived at by removing features from any of the embodiments described herein. Aspects of the system can be modified, if necessary, to employ the systems, functions, and concepts of the various references described above to provide yet further examples of the technology.

From the foregoing, it will be appreciated that many alterations, modifications, additions and permutations are possible within the practice of this invention. Specific examples of systems, methods and apparatuses have been described herein for purposes of illustration. The embodiments described herein are only examples. Other example embodiments may be obtained, without limitation, by combining features of the disclosed embodiments. Embodiments described herein may be practised or implemented without all of the features ascribed to them. Such variations on described embodiments that would be apparent to the skilled addressee, including variations comprising mixing and matching of features from different embodiments, are within the scope of this invention.

These and other changes can be made to the system in light of the above description. While the above description describes certain examples of the technology, and describes the best mode contemplated, no matter how detailed the above appears in text, the technology can be practiced in many ways. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific examples disclosed in the specification, unless the above description section explicitly and restrictively defines such terms. Accordingly, the actual scope of the technology encompasses not only the disclosed examples, but also all equivalent ways of practicing or implementing the technology under the claims.

As will be apparent to those skilled in the art in light of the foregoing disclosure, many alterations and modifications are possible in the practice of this invention without departing from the spirit or scope thereof. For example:
Investment constraints may account for investments that cannot be re-scheduled (e.g., because they are approved or are already executing). For example, investment constraints may be adjusted to reflect such fixed investments. For another example, fixed investments may be modeled by treating their fixed replacement dates as unmonetizable failure risk replacement dates.
Different in-place assets replaceable with the same type of replacement asset may be treated as an asset class, and the investment schedules for each of the different in-place assets combined to provide an investment schedule for the asset class. For example, where power poles installed in different calendar years and in different climactic regions are separately scheduled for replacement as different pooled assets, the schedules for replacing in-place power poles of each pool may be combined to a schedule for installing replacement power poles throughout the organization. Advantageously, this may help in scheduling purchases of the type of replacement asset.
Different assets whose functions combine to produce a result (e.g., different assets operating as parts of the same assembly, different assets belonging to a revenue generating unit, etc.) may be treated as an asset class, and the investment schedule for the each of the different assets combined to provide an investment schedule for the asset class. For example, where the spillway gate and turbine of a hydroelectric generating station are treated as separate assets for the purpose of scheduling their replacement, the replacement investment for the station may be provided as the sum of the investment schedules for the spillway gate and the turbine.
Tools and methods according to embodiments of the invention need not derive the example component cost curves shown in FIG. 2 in order to arrive at a total cost curve. For example, the example component cost curves shown in FIG. 2 may embody combinations of other cost curves (e.g., lost cost advantage curve 24 may embody a difference between operating cost curves for an in-place capital asset and its replacement), and a total cost curve may be derived by combining such other cost curves directly.
While ‘costs’ may be represented in units of currency, such as dollars, euros, or the like, this is not mandatory. Costs may be represented in arbitrary units or in units of some other resource. In some embodiments it is convenient to represent costs in monetary units and/or to convert costs into monetary units for presentation. however, this is not mandatory in all embodiments.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A machine implemented method for scheduling investments in capital assets, the method comprising:
for each of a plurality of in-place capital assets under management:
executing by a data processor a replacement deferral risk cost model with replacement deferral risk cost information as an input, the replacement deferral risk cost model estimating costs of failure risked by deferring replacement of the in-place asset as a function of time;
executing by the data processor a first use model with first use cost information as an input, the first use model estimating use costs of the in-place capital asset as a function of time;
executing by the data processor a second use model with second use cost information as an input, the second use model estimating use costs of a replacement for the in-place capital asset as a function of time;
executing by the data processor a replacement cost model with replacement cost information as an input, the replacement cost model estimating costs associated with replacing the in-place asset with the replacement asset as a function of time;
determining by the data processor from outputs of the failure model, the first and second use models and the replacement cost model a total cost function for the capital asset over a planning period as a function of replacement date for the capital asset; and
determining by the data processor a financially optimal replacement date for the in-place capital asset based on the total cost function; and
storing and/or outputting to non-transitory media a record comprising the financially optimal replacement dates for one or more of the in-place capital assets.

2. A machine implemented method according to claim 1 wherein determining the financially optimal replacement date for the in-place capital assets comprises determining a minimum of the total cost functions corresponding to the in-place capital assets.

3. A machine implemented method according to claim 1 comprising, for a plurality of select ones of the in-place capital assets:
determining deferral cost metrics based on the total cost functions corresponding to the select in-place capital assets for the corresponding financially optimal replacement dates; and
automatically generating ranking information prioritizing replacement of the select in-place capital assets based at least in part on the determined deferral cost metrics; and
including the ranking information in the report.

4. A machine implemented method according to claim 3 wherein the deferral cost metrics comprise slopes of the total cost functions corresponding to the select in-place capital assets at the corresponding financially optimal replacement dates.

5. A machine implemented method according to claim 3 wherein the deferral cost metrics comprise ratios of the incremental costs for deferring replacement of the select in-place capital assets to the costs indicated by the total cost functions at the financially optimal replacement dates.

6. A machine implemented method according to claim 1 wherein the first use cost information and second use cost information comprise information regarding consumption of resource units of one or more types.

7. A machine implemented method according to claim 6 comprising relating resource units to monetary costs.

8. A machine implemented method according to claim 6 comprising relating future expenditures of resource units to monetary costs, and, for resource units of first and second types determining values of future expenditures of resource units as of a reference date based on corresponding first and second different functions.

9. A machine implemented method according to claim 6 comprising generating a summary of the estimated expenditure of resource units of each of plurality of different types in each of a plurality of future periods.

10. A machine implemented method according to claim 1 wherein the asset information for at least one of the in-place capital assets includes unmonetizable failure information, and comprising:
for the at least one in-place capital asset:
determining one or more unmonetizable risk replacement dates; and
determining an optimal replacement date as the earliest of the unmonetizable risk replacement dates and the financially optimal replacement date, and
for the remainder of the in-place capital assets:
determining an optimal replacement date based on the financially optimal replacement date.

11. A machine implemented method according to claim 10 wherein for the at least one in-place capital asset the unmonetizable failure information comprises unmonetizable failure probability information and consequence risk tolerance information, and wherein determining the one or more unmonetizable risk replacement dates for the at least one in-place capital asset comprises:
executing an unmonetizable failure probability model with the unmonetizable failure information as an input, the unmonetizable failure probability model estimating probability of one or more types of unmonetizable failure as a function of time; and
determining from the output of the unmonetizable failure probability model and the consequence risk tolerance information an earliest date of intolerable risk for each of the one more types of unmonetizable failure.

12. A machine implemented method according to claim 11 wherein each of the one or more types of unmonetizable failure is associated with one of a plurality of severity levels, and wherein the consequence risk tolerance information comprises a plurality of probability thresholds corresponding to the severity levels.

13. A machine implemented method according to claim 1 comprising for each of the in-place capital assets determining an optimal replacement date based on the financially optimal replacement date for the in-place capital asset.

14. A machine implemented method according to claim 5 wherein the asset information includes replacement investment information, and the method comprises:
determining an optimal replacement investment schedule based on the optimal replacement dates determined for the in-place capital assets and the replacement investment information; and
determining whether the optimal replacement investment schedule exceeds an investment constraint.

15. A machine implemented method according to claim 14 wherein the software instructions are configured to cause the data processor identify the select in-place capital assets by identifying ones of the in-place capital assets whose replacement investments contribute to the investment schedule exceeding the investment constraint in a time window.

16. A machine implemented method according to claim 15 wherein identifying ones of the in-place capital assets whose replacement investments contribute to the investment schedule exceeding the investment constraint in a time window comprises identifying only ones of the in-place capital assets whose replacement investments begin in the time window.

17. A machine implemented method according to claim 14 comprising deferring a scheduled replacement date of at least one of the select in-place capital assets based on the ranking information.

18. A machine implemented method according to claim 17 wherein deferring the scheduled replacement date of the at least one of the select in-place capital assets comprises deferring scheduled replacement dates of only the select in-place capital assets whose optimal replacement dates do not correspond to the assets' unmonetizable failure replacement dates.

19. A machine implemented method according to claim 17 wherein deferring the scheduled replacement date of the at least one of the select in-place capital assets comprises deferring scheduled replacement dates of the select in-place capital assets no later than the assets' respective unmonetizable failure replacement dates.

20. A machine implemented method according to claim 17 wherein deferring the replacement of the at least one select in-place capital asset based on the ranking information comprises, after deferring the replacement of at least one of the select in-place capital assets, determining, at least for the time window, a revised replacement investment schedule reflecting the deferral of the replacement of the at least one of the select in-place capital assets.

21. A machine implemented method according to claim 20 comprising:
determining whether the revised replacement investment schedule exceeds the investment constraint in the time window, and
if the revised replacement investment schedule does not exceed the investment constraint in the time window, identifying a divisible portion of the replacement investment deferred by the deferral of the one of the select in-place capital assets, the divisible portion sufficiently small to be accommodated within the investment constraint for the time window; and
restoring the previously scheduled replacement of the portion of the one of the select in-place capital assets corresponding to the identified divisible portion of the replacement investment.

22. A machine implemented method according to claim 21 comprising updating the financially optimal replacement date of the portion of the one of the select in-place capital assets corresponding to the complement of the identified divisible portion of the replacement investment.

23. A machine implemented method according to claim 20 comprising:
(a) determining whether the revised replacement investment schedule exceeds the investment constraint in the time window,
(b) if the revised replacement investment schedule exceeds the investment constraint in the time window, deferring a scheduled replacement date of at least one other of the select in-place capital assets based on the ranking information,
(c) updating the revised replacement investment schedule to reflect the deferral of the scheduled replacement of the at least one other of the select in-place capital assets, and
(d) repeating steps (a) to (c) until the revised investment schedule does not exceed the investment constraint in the time window.

24. A machine implemented method according to claim 23 comprising:
determining based on first asset information a first investment schedule that satisfies the investment constraint,
determining based on second asset information a second investment schedule that satisfies the investment constraint, and
generate a consensus replacement schedule based on the first and second investment schedules and at least one difference between the first asset information and the second asset information.

25. A machine implemented method according to claim 23 wherein two or more of the plurality of in-place capital assets have the same type of replacement asset, and comprising determining an investment schedule for an asset class comprising the two or more in-place capital assets by combining the investment schedules for the two or more in-place capital assets.

26. A machine implemented method according to claim 12 wherein two or more of the plurality of in-place capital assets have functions that combine to produce a result, and comprising determining an investment schedule for an asset class comprising the two or more in-place capital assets by combining the investment schedules for the two or more in-place capital assets.

27. A machine implemented method according to claim 15 comprising determining, for at least the time window, an expected cost of replacing failed ones of a plurality of run-to-failure assets, and wherein the investment constraint, at least in the time window, reflects an expected cost of replacing failed ones of a plurality of run-to-failure assets.

28. A machine implemented method according to claim 15 comprising forecasting, for at least the time window, an investment in replacement of a yet-to-be-installed capital asset based on an expected end of life of the yet-to-be-installed capital asset, and wherein the investment constraint reflects, at least in the time window, the forecast investment.

29. A machine implemented method according to claim 28 wherein the yet-to-be-installed capital asset comprises a scheduled replacement for one of the in-place capital assets, and wherein the expected end of life of the yet-to-be-installed capital asset is based on the scheduled replacement date of its corresponding in-place capital asset.

30. A machine implemented method according to claim 1 wherein the asset information includes replacement investment information, and wherein the method comprises:
determining an optimal replacement investment schedule based on the optimal replacement dates determined for the in-place capital assets and the replacement investment information; and
determining whether the optimal replacement investment schedule exceeds a constraint on resource units.

31. A machine implemented method according to claim 30 wherein the method comprises:
identifying the select in-place capital assets by identifying ones of the in-place capital assets whose replacement investments contribute to the investment schedule exceeding the constraint on resource units in a time window.

32. A machine implemented method according to claim 31 wherein the method comprises:
in identifying ones of the in-place capital assets whose replacement investments contribute to the investment schedule exceeding the constraint on resource units in a time window:
identifying only ones of the in-place capital assets whose replacement investments begin in the time window.

33. A machine implemented method according to claim 30 wherein the method comprises: deferring a scheduled replacement date of at least one of the select in-place capital assets based on the ranking information.

34. A machine implemented method according to claim 33 wherein the method comprises:
in deferring the scheduled replacement date of the at least one of the select in-place capital assets:
deferring scheduled replacement dates of the select in-place capital assets no later than the assets' respective unmonetizable failure replacement dates.

35. A machine implemented method according to claim 28 wherein the yet-to-be-installed capital asset comprises a scheduled replacement for another corresponding yet-to-be-installed capital asset, and wherein the expected end of life of the yet-to-be-installed capital asset is based on a scheduled replacement date of its corresponding other yet-to-be-installed capital asset.

36. A machine implemented method according to claim 1 wherein the database stores asset information for a new capital asset, the asset information for the new capital asset comprising at least: second use cost information, and replacement cost information, and
wherein the software instructions configured to cause the data processor to:
for the new capital asset:
execute a second use model with the second use cost information as an input, the second use model estimating use costs of the new capital asset as a function of time;
execute a replacement cost model with the replacement cost information as an input, the replacement cost model estimating costs of installing the new asset as a function of time;
determine from outputs of the second use model and the replacement cost model a total cost function for the new capital asset over a planning period as a function of installation date for the capital asset; and
determine a financially optimal replacement date for the new capital asset based on the total cost function.

37. A machine implemented method according to claim 1 wherein at least one of the plurality of in-place capital assets comprises a divisible asset.

38. A machine implemented method according to claim 37 wherein the divisible asset comprises a pool of two or more assets, and wherein the asset information for the at least one of the plurality of in-place capital assets is representative of the two or more assets belonging to the pool.

39. A machine implemented method according to claim 1 comprising automatically determining the optimal replacement dates for the in-place capital assets when asset information stored in the database is updated.

40. A machine implemented method according to claim 1 wherein the replacement deferral risk cost information for at least one of the plurality of in-place capital assets includes condition information derived from an inspection of the in-place capital asset and the replacement deferral risk cost model is configured to determine the probability of failure based at least in part on the condition information.

41. A machine implemented method according to claim 1 wherein the replacement deferral risk cost information for at least one of the plurality of in-place capital assets includes an estimate of costs of collateral damage to other ones of the in-place capital assets caused by failure of the in-place capital asset.

42. A machine implemented method according to claim 1 wherein the replacement deferral risk cost information for at least one of the plurality of in-place capital assets includes an estimate of lost income resulting from failure of the in-place capital asset.

43. A machine implemented method according to claim 1 wherein the estimate of lost income for at least one of the plurality of in-place capital assets includes an estimate of lost tax credits for generating green power.

44. A machine implemented method according to claim 1 wherein the replacement cost information for at least one of the plurality of in-place capital assets includes a replacement investment profile.

45. A machine implemented method according to claim 1 wherein the first use cost information for at least one of the plurality of in-place capital assets includes a forecast of demand on the capacity of the at least one in-place asset.

46. A machine implemented method according to claim 1 wherein the forecast of demand on the capacity of the at least one in-place asset is based on a proxy for demand on the capacity.

47. A machine implemented method according to claim 10 wherein the asset information includes replacement investment information, and the method comprises:
scheduling investments in asset replacements whose optimal replacement dates correspond to investment start dates in a time window in order according to the ranking of the deferral cost metrics until scheduling of an investment in a next asset replacement whose optimal replacement date corresponds to an investment start date in the time window would cause the sum of investments scheduled for the time window to exceed an investment constraint.

48. A machine implemented method according to claim 10 wherein the asset information includes replacement investment information, and the method comprises:
scheduling investments in asset replacements whose unmonetizable risk replacement dates correspond to investment start dates in a time window; and then
scheduling investments in remaining asset replacements whose optimal replacement dates correspond to investment start dates in the time window in order according to the ranking of the deferral cost metrics until scheduling of an investment in a next asset replacement whose optimal replacement date corresponds to an investment start date in the time window would cause the sum of investments scheduled for the time window to exceed an investment constraint.

49. A machine-implemented method according to claim 1 comprising checking the financially optimal replacement dates for compliance with a plurality of rules specifying relationships between different ones of the capital assets.
